(19) United States
(12) Patent Application Publication
(10) Pub. No.: US 2011/0153463 A1
(43) Pub. Date: Jun. 23, 2011

(54) Methods and systems for transmitting over a network information pertaining to jewelry, and more particularly, to methods and systems for enabling manipulation and arrangement of images representing jewelry components over a network for the purpose of creating, designing, sharing, reviewing and/or purchasing a custom jewelry design; and to methods and systems for managing the images for a custom jewelry design with content management systems, databases and e-commerce technology over a network and/or through the use of a mobile device or a kiosk

(76) Inventor: Gunnar Lovelace, Ojai, CA (US)

(21) Appl. No.: 12/653,810

(22) Filed: Dec. 21, 2009

(51) Int. Cl. G06Q 30/00; G06Q 50/00; G09G 5/00

(52) U.S. Cl. 705/27.1; 345/619; 345/629; 705/26.5

(57) ABSTRACT

A method and system for transmitting images over a network and/or mobile device or kiosk for communication, advertisement, commerce, marketplace, customer relationship, accounting, content management and/or verification of information pertaining to jewelry.

### TECHNICAL FIELD

The present invention generally relates to transmitting over a network information pertaining to jewelry, and more particularly, to methods and systems for enabling manipulation and arrangement of bitmap images (and/or photograph(s) with a transparent layer) representing jewelry components over a network for the purposes of creating, designing, sharing, reviewing and purchasing a custom jewelry design; and to methods of managing the bitmap images (and/or photograph(s) with a transparent layer) representing jewelry components in the custom jewelry design with content management systems, databases and e-commerce technology over a network and/or through the use of a mobile device or a kiosk.

### BACKGROUND

Digital networks, including the Internet and mobile telephony, are rapidly transforming the way information is being disseminated in the public and are augmenting traditional forms of communication such as mail, overnight express mail, landline telephone and facsimile. Individuals are increasingly seeking to conduct commerce over networks; commonly referred to as Electronic Commerce or e-commerce for short. E-commerce permits anyone having access to a network access to potential commercial transactions. However, some e-commerce shoppers are not satisfied with purchasing standardized products and services that do not adequately match their unique needs and/or preferences. Also, given the Internet'subiquitous nature and the concomitant potential for large numbers of online inquiries about obtaining customized products and/or services to be made by potential purchasers, some of which may be merely “shopping” (i.e., not serious about purchasing but merely looking for recreational purposes), sellers need to be able to respond succinctly and efficiently to these inquiries. Moreover, potential purchasers and sellers need to be able to communicate with each other the details of a customized product and/or service including in some cases the terms of the transaction. However, in some instances the parties are not available for communication over a network at the same time. For example, an individual in the United States may want to inquire about obtaining a customized product and/or service from a potential seller in India who is asleep at that time due to differences in these regions' time zones.

As can be seen, there is a need for providing up-to-date information pertaining to potential and/or completed transactions involving customizable products and/or services over a network. In addition, there is a need for verifying information pertaining to potential and/or completed transactions involving customizable products and/or services over a network. In addition, there is a need for providing communication, advertisement, commerce, marketplace, customer relationship management, content management, accounting and verification of information pertaining to potential and/or completed transactions involving customizable products and/or services over a network.

### SUMMARY OF THE INVENTION

In one exemplary embodiment of the present invention, a processor implemented method for designing jewelry over a network, includes the steps of: transmitting over a network a plurality of bitmap images (and/or photograph(s) with a transparent layer) to be viewed on a display, wherein each bitmap image (and/or photograph with a transparent layer): depicts at least one jewelry component, is indexed through the use of a processor to an inventory of at least one jewelry component, and is configured such that a location or orientation of the bitmap image (and/or photograph with a transparent layer) on a display can be changed using input from at least one individual; and combining through the use of a processor the plurality of bitmap images (and/or photograph(s) with a transparent layer) into a single image.

In another exemplary embodiment of the present invention, a computer implemented method for designing jewelry over a network, includes the steps of: transmitting a plurality of bitmap images (and/or photograph(s) with a transparent layer), each of which depicts at least one jewelry component, wherein each of the plurality of bitmap images (and/or photograph(s) with a transparent layer) is indexed to a price of at least one jewelry component, and is configured such that its location on a display or view angle can be changed using input received over a network from at least one individual; and combining through the use of a processor the plurality of bitmap images (and/or photograph(s) with a transparent layer) representing jewelry components into a single image.

In still another exemplary embodiment of the present invention, a jewelry content management system, includes: means for transmitting a plurality of bitmap images (and/or photograph(s) with a transparent layer) representing jewelry components over a network, wherein at least one of the bitmap images depicts jewelry and each of the plurality of images corresponds to both a jewelry component in an inventory and to a price, and is configured so that at least one of its location on a display and a view angle can be changed using input from at least one individual over a network; means for displaying the plurality of bitmap images (and/or photograph(s) with a transparent layer) representing jewelry components; and means for combining the plurality of bitmap images (and/or photograph(s) with a transparent layer) representing jewelry components into a single image, wherein the means for combining comprises a computer.

These and other features, aspects and advantages of the present invention will become better understood with reference to the following drawings, description and claims.

### BRIEF DESCRIPTION OF THE DRAWINGS

FIG. 1 is a simplified schematic view of a geographic area in which a method and/or system of the present invention may be used according to an exemplary embodiment of the present invention.

FIG. 2 is a simplified schematic view of two types of devices, a personal computer and a wireless device, both of which have access to at least one network such as the Internet and/or a wireless network, which may be used according to an exemplary embodiment of a method and/or system of the present invention.

FIG. 3 is a block diagram showing the internal functional architecture of a computer according to an exemplary embodiment of a method and/or system of the present invention.

FIG. 4 shows a topology of a network with computers and wireless devices connected to a network, which is an integrated Internet and wireless network according to an exemplary embodiment of a method and/or system of the present invention.

FIG. 5 shows a schematic layout of data connections between clients and servers for managing communication, advertisement, commerce, customer relationship management, content management, accounting and/or verification of information pertaining to jewelry over a network according to an exemplary embodiment of a method and/or system of the present invention.

FIG. 6 shows an interface, which is configured to enable the displaying of a jewelry design and an information display, displayed by a host computer and/or a wireless device for executing a method and/or system according to one exemplary embodiment of the present invention.

FIG. 7 shows an interface, which is configured to enable the displaying of a web based affiliate management program for affiliates who seek to drive traffic to a custom design jewelry application over a network, displayed by a host computer and/or a wireless device for executing a method and/or system according to one exemplary embodiment of the present invention.

FIG. 8 shows an interface, which is configured to enable the displaying of a master administrator report that is capable of displaying all of the affiliates for the designer jewelry application, displayed by a host computer and/or a wireless device for executing a method and/or system according to one exemplary embodiment of the present invention.

FIG. 9 shows an interface, which is configured to enable the displaying of information pertaining to how prospective affiliates of the custom jewelry application are able to sign up and create accounts via a network connection, displayed by a host computer and/or a wireless device for executing a method and/or system according to one exemplary embodiment of the present invention.

FIG. 10 shows an interface, which is configured to enable the displaying of an interface configured to enable an administrator to log onto a content management system of the Custom Design Jewelry Application and to manage jewelry Components (which are represented in the interface as bitmap images or photographs with transparent layer), displayed by a host computer and/or a wireless device for executing a method and/or system according to one exemplary embodiment of the present invention.

FIG. 11 shows an interface configured to enable the displaying of information, such as data arranged in categories and an overview of categories of products, to an administrator of the custom jewelry application within the content management system, displayed by a host computer and/or a wireless device for executing a method and/or system according to one exemplary embodiment of the present invention.

FIG. 12 shows a interface configured to enable the displaying of information (e.g. information viewable by an Administrator), such as a taxonomy of the jewelry components (such as “Hanging Heart Perfume”) categories in the content management system displayed by a host computer and/or a wireless device for executing a method and/or system according to one exemplary embodiment of the present invention.

FIG. 13 shows an interface configured to enable the displaying of information, such as how many times a specific jewelry component and/or finished design has been viewed, for example to an administrator within the content management system, displayed by a host computer and/or a wireless device for executing a method and/or system according to one exemplary embodiment of the present invention.

FIG. 14 shows an interface configured to enable the displaying of a virtual gift card that can be purchased by users to give as gifts to friends or family for use with the Custom Jewelry Design Application, displayed by a host computer and/or a wireless device for executing a method and/or system according to one exemplary embodiment of the present invention.

FIG. 15 shows an interface configured to enable the displaying of a checkout process for the Custom Jewelry Design Application, displayed by a host computer and/or a wireless device for executing a method and/or system according to one exemplary embodiment of the present invention.

FIG. 16 shows an interface configured to enable the displaying of a checkout process for the Custom Jewelry Design Application, displayed by a host computer and/or a wireless device for executing a method and/or system according to one exemplary embodiment of the present invention.

FIG. 17 shows an interface configured to enable the displaying of a user interface of the Custom Jewelry Design Application, displayed by a host computer and/or a wireless device for executing a method and/or system according to one exemplary embodiment of the present invention.

FIG. 18 shows an interface configured to enable the displaying of an e-mail that is generated when a user sends a custom jewelry design to another person from a user interface, displayed by a host computer and/or a wireless device for executing a method and/or system according to one exemplary embodiment of the present invention.

FIG. 19 shows an interface configured to enable the displaying of an interface where users of wholesale accounts to the Custom Jewelry Design Application can log in and/or create an account.

FIG. 20 shows a flow chart of an example of operation of one exemplary embodiment of a method for designing jewelry over a network.

FIG. 21 shows a flow chart of an example of operation of one exemplary embodiment of a method for designing jewelry over a network.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention generally involves the enablement of manipulation and arrangement of bitmap images (and/or photographs with a transparent layer) representing jewelry components over a network for the purposes of creating, designing, sharing, reviewing and purchasing a custom jewelry design; and to managing bitmap images (and/or photographs with a transparent layer) representing jewelry components and custom jewelry designs with content management systems, databases and e-commerce technology over a network, mobile device or kiosk.

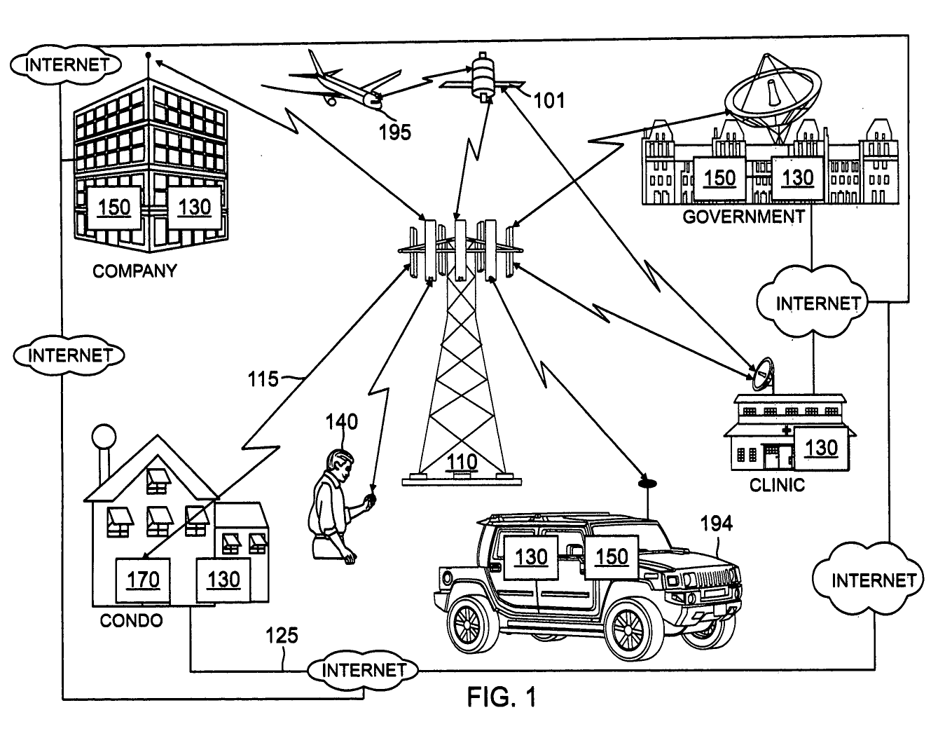

Referring now to the figures, FIG. 1 is a simplified schematic view of a geographic area in which a method and/or system of the present invention may be used according to an exemplary embodiment of the present invention. FIG. 1 includes a wireless network 115 (including both a satellite 101 and a wireless tower 110), the Internet 125, computers 130 and 170, a wireless device 140 (shown held by an individual), databases 150 and vehicles 194 and 195 for executing a method and/or system according to one exemplary embodiment of the present invention.

In one exemplary embodiment of the present invention, wireless network 115 includes a satellite system 101 but not a wireless tower 110. In one exemplary embodiment of the present invention, wireless network includes a wireless tower 110 but not a satellite system 101. Internet 125 includes but is not limited to intranets, local area networks and wide area networks. Computers 130 and 170 include but are not limited to personal computers, stand alone computers, tower computers, servers, desktop computers, laptop computers, notebook computers, personal digital assistants, work stations, main frames, tablet computers, minicomputers, e-readers, supercomputers and wearable computers. Moreover, each computer 130 and 170 can be a special purpose computer programmed to perform the disclosed algorithms. Wireless device 140 includes but is not limited to cell phones, personal digital assistants, wireless internet cards, wireless modems, e-readers, tablet personal computers and smart cards. Databases 150 include but are not limited to relational databases, object databases and post-relational databases. According to one exemplary embodiment of the present invention, a computer 130 and a database 150 can be coupled together via a LAN, an Ethernet connection, a WAN, a wireless connection and/or a power line and can be placed in a location such as but not limited to a government facility, a private company facility, a clinic, a vehicle or the like. Vehicles 194 and 195 include but are not limited to government vehicles (such as U.S. Postal vehicles), commercial entities vehicles (such as Federal Express, UPS and DHL) or individuals' vehicles. Wireless devices allow sellers and buyers to maintain up-to-date and in some cases real time communication. Sellers may include but are not limited to any of the following: private citizens, members of government, members of for profit and non-profit organizations, all of which are capable of communicating and delivering products and/or services at a fixed store front or via a mobile storefront according to an exemplary embodiment of a method and/or system of the present invention. Sellers' schedules and availability to meet potential purchasers can be communicated via a network according to an exemplary embodiment of a method and/or system of the present invention. Purchasers' requests can be queued in one or more computers 130 and 170 until such requests can be processed according to an exemplary embodiment of a method and/or system of the present invention. According to one exemplary embodiment of the present invention, vehicles 194 and 195 can contain computer(s) 130, database(s) 150 and/or products and/or services. Moreover, according to one exemplary embodiment of the present invention, individuals using wireless devices (such as the one being held 140) can send and receive information according to one embodiment of the present invention.

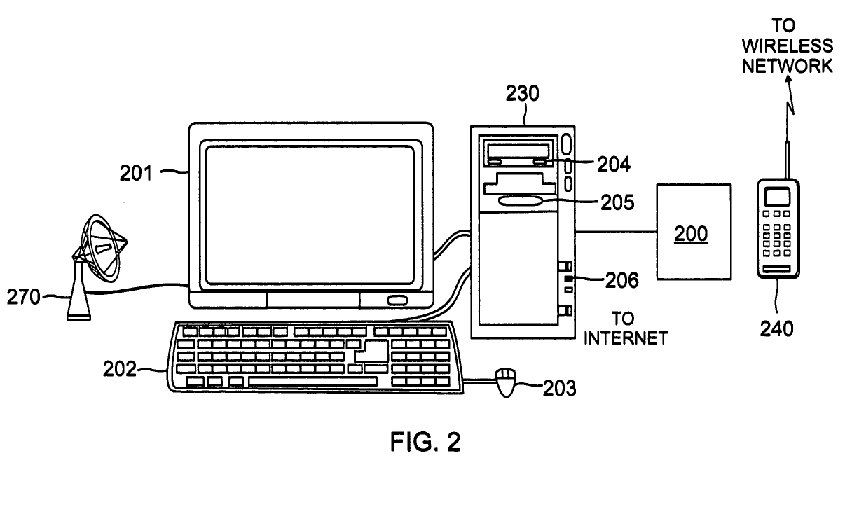

FIG. 2 includes a host computer 230, a monitor 201, a database 200 and a wireless device 240. Monitor 201 may be a CRT type, an LCD type, a touch sensitive screen, or any other type of color or monochrome display according to one exemplary embodiment of the present invention. Also provided with computer 230 may be a keyboard 202 for entering text data and user commands, and a pointing device 203 (such as a mouse) for processing objects displayed on monitor 201 according to an exemplary embodiment of the present invention. Database 200 may be integrated within computer 230 according to an exemplary embodiment of the present invention. User can be a single individual, a plurality of individuals, an automated program, and/or a combination of any of these entities.

Computer 230 may include a computer-readable memory medium such as a rotating disk 204 (or a similar type of storage medium) for storing readable data according to an exemplary embodiment of the present invention. Besides other programs, disk 204 can store application programs including web browsers by which computer 230 can be connected to a network, such as the Internet, and the systems described below, according to an exemplary embodiment of the present invention.

Computer 230 can also access a computer-readable floppy disk storing data files, application program files, and computer executable method steps embodying the present invention or the like via a floppy disk drive 205 according to an exemplary embodiment of the present invention. A CD-ROM interface (not shown) may also be provided with computer 230 to access application program files, audio files and data files stored on a CD-ROM according to an exemplary embodiment of the present invention. Computer 230 may access files and/or programs on other computers or on a database via the internet or a wireless network according to an exemplary embodiment of the present invention;

A modem, an integrated services digital network (ISDN) connection, a wireless connection, a satellite dish or the like may also provide computer 230 with a connection to the Internet according to an exemplary embodiment of the present invention. An Internet connection 206 may allow the computer 100 to download data files, audio files, application program files and processor-executable method steps according to an exemplary embodiment of the present invention. Computer 230 may include a wireless modem and/or connection to a satellite dish 270 (or similar type of wireless connection such as an antenna manufactured by KVH Industries, Inc.) for access to a wireless network according to an exemplary embodiment of the present invention.

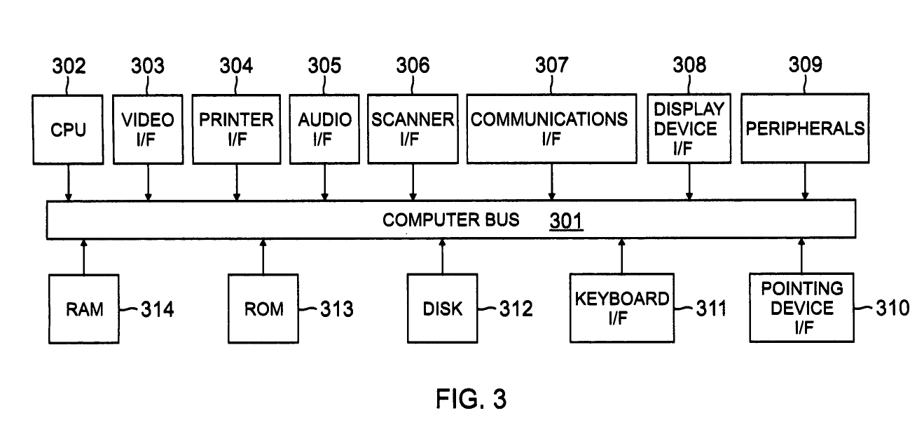

FIG. 3 is a block diagram showing the internal functional architecture of computer 230 (shown in FIG. 2) according to an exemplary embodiment of the present invention. As shown in FIG. 3, computer 230 (as shown in FIG. 2) may include a CPU 302 for executing processor-executable method steps and interfaces with a computer bus 301 according to an exemplary embodiment of the present invention. Also shown in FIG. 3 are a video interface 303, a printer interface 304, an audio interface 305, a scanner interface 306, a communication interface 307 (such as a web or wireless interface), a display device interface 308, a peripherals interface 309, a pointing device interface 310, a keyboard interface 311, a disk 312, read only memory (ROM) 313 and random access memory 314 according to an exemplary embodiment of the present invention. Peripherals Interface 309 provides connectivity to such things as a database, a scanner, a microphone, a video camera, a three dimensional fax machine, a lathe, a smart card terminal, a biometric scanner for receiving different types of biometric information from an individual, such as but not limited to finger print, retinal scan and a hand writing sample, which can chosen at random. According to one exemplary embodiment of the present invention, the system and/or method of the present invention is configured to enable sellers, purchasers, advertisers and/or possessors of products and/or services to input their personal information using a scanner, a microphone, a video camera, a three dimensional fax machine a smart card terminal and/or a biometric scanner.

As described above, disk 204 (shown in FIG. 2) may store operating system program files, application program files, web browsers, and other files according to an exemplary embodiment of the present invention. Some of these files may be stored on disk 204 (shown in FIG. 2) using an installation program according to an exemplary embodiment of the present invention. For example, CPU 302 may execute processor-executable method steps of an installation program so that CPU 302 can properly execute the system and/or method according to an exemplary embodiment of the present invention.

A random access main memory (“RAM”) 314 may also interface to computer bus 301 to provide CPU 302 with access to memory storage according to an exemplary embodiment of the present invention. When executing stored computer-executable method steps from disk 204 (or other storage media such as floppy disk 205, both shown in FIG. 2, or internet connection such as 206, shown in FIG. 2), CPU 302 stores and executes the method steps out of RAM 314 according to an exemplary embodiment of the present invention.

Read only memory (“ROM”) 313 may be provided to store invariant instruction sequences such as start-up instruction sequences or basic input/output operating system (BIOS) sequences for operation of keyboard 202 (shown in FIG. 2) according to an exemplary embodiment of the present invention.

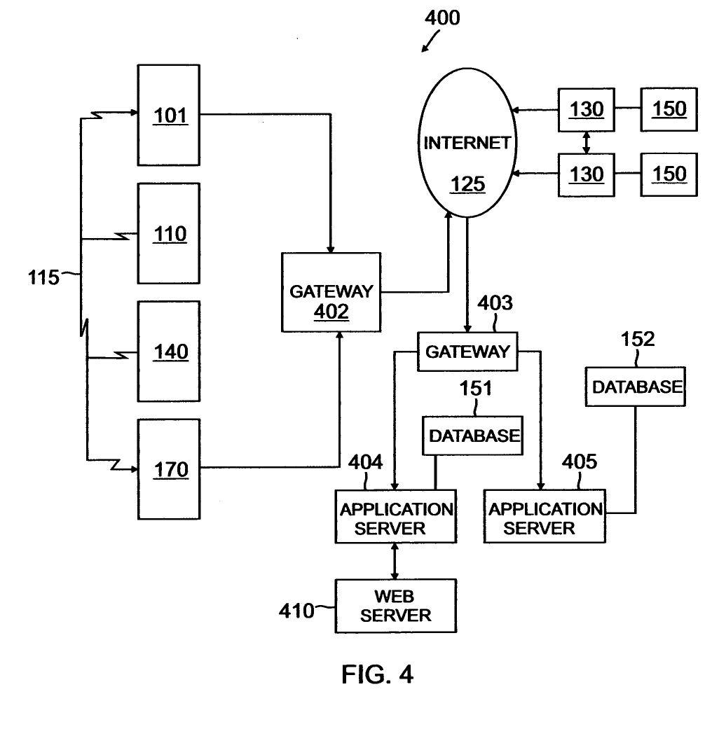

FIG. 4 shows a typical topology of an integrated wireless/Internet network 400 according to an exemplary embodiment of the present invention. For illustration purposes, a satellite 101, a wireless tower 110, a wireless device 140 and a computer 170 are shown connected to each other through a wireless network 115 and to the Internet 125 through a gateway 402 (which can be wired or wireless) according to an exemplary embodiment of the present invention. Also shown in FIG. 4 are computers 130 connected to each other, to databases 150 and to the Internet 125 via a communication interface. According to an exemplary embodiment of the present invention, communication interface may be a modem, a network Interface card, or a unit for providing connectivity to other computer systems over a network using protocols such as X.25, Ethernet, or TCP/IP, interactive voice response, or any device that allows, directly or indirectly, computer-to-computer communications. According to an exemplary embodiment of the present invention, network can include an Internet network but not a wireless network. According to an exemplary embodiment of the present invention, network can include a wireless network but not an internet network.

It is noteworthy that the invention is not limited to a particular number of computers or wireless devices. Any number of computers or wireless devices that can be connected to a network, such as a wireless network 115 or the Internet 125 (both shown in FIGS. 1 and 3), or any other network, may be used.

FIG. 4 further shows a second gateway 403 that may connect a network of application servers 404 and 405 to the Internet 125 according to an exemplary embodiment of the present invention. Application servers 404 and 405 may be connected with each other over a computer network according to an exemplary embodiment of the present invention. A web server 410 may be connected to an application server, such as application server 404 according to an exemplary embodiment of the present invention. Application servers 404 and 405 can provide content, including information about a product and/or service, to a user from database 151 and/or 152 according to an exemplary embodiment of the present invention. Application servers 404 and 405 can execute a method and/or system of the present invention according to an exemplary embodiment of the present invention.

The Internet connects thousands of computers worldwide through well-known protocols, for example, Transmission Control Protocol (TCP)/Internet Protocol (IP), into a vast network. Information on the Internet is stored world wide as computer files, mostly written in the Hypertext Mark Up Language (“HTML”). Other mark up languages, e.g., Extensible Markup Language (“XML”) as published by W3C Consortium, Version 1, Second Edition, October 2000, ©W3C may also be used. The collection of all such publicly available computer files is known as the World Wide Web (“WWW”). The WWW is a multimedia-enabled hypertext system used for navigating the Internet and is made up of hundreds of thousands of web pages with images and text and video files, which can be displayed on a computer monitor or wireless device having a screen. Each web page can have connections to other pages, which may be located on any computer connected to the Internet.

A typical Internet user uses a client program called a “Web Browser” to connect to the Internet. A user can connect to the Internet via a proprietary network, such as America Online, or via an Internet Service Provider, e.g., Time Warner's Road Runner service. The web browser may run on any computer or wireless device connected to the Internet. Currently, various browsers are available of which two prominent browsers are Firefox and Microsoft Internet Explorer. The Web Browser receives and sends requests to a web server and acquires information from the WWW. A web server is a program that, upon receipt of a request, sends the requested data to the requesting user. A standard naming convention known, as Uniform Resource Locator (“URL”), has been adopted to represent hypermedia links and links to network services. Most files or services can be represented with a URL.

URLs enable Web Browsers to go directly to any file held on any WWW server. Information from the WWW is accessed using well-known protocols, including the Hypertext Transport Protocol (“HTTP”), the Wide Area Information Service (“WAIS”) and the File Transport Protocol (“FTP”), over TCP/IP protocol. The transfer format for standard WWW pages is Hypertext Transfer Protocol (HTTP).

Wireless network 115 includes any type of communication network that is wireless (i.e., information transmission system that uses electromagnetic waves, such as radio waves, as the carrier of information), and can include but is not limited to any telecommunications network whose interconnections between nodes is implemented without the use of wires. Wireless network can include but is not limited to: wireless personal area network (WPAN), Bluetooth, ZigBee, Wi-Fi, IEEE 802.11, microwave, WiMAX, IEEE 802.16d/802.16e, Global System for Mobile Communications (GSM), Personal Communication Service (PCS), D-AMPS, wireless LAN (WLAN), 1G, 2G, 2.5 G and 3G.

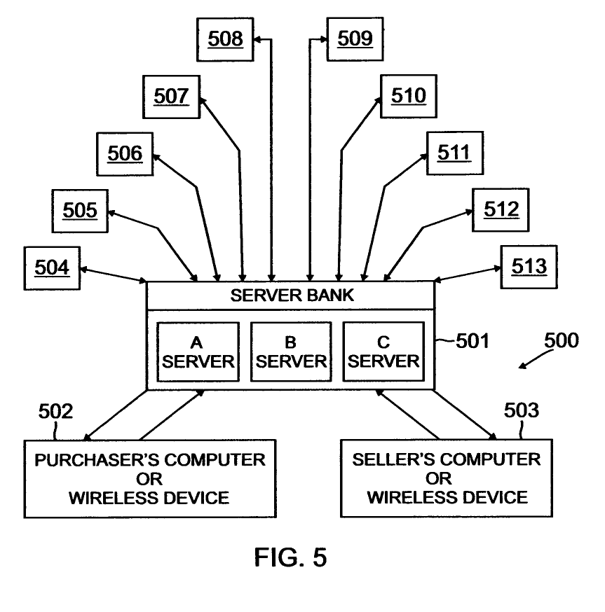

FIG. 5 shows a layout of data connections between clients and servers 500 for managing communication, advertisement, commerce, customer relationship management, content management, accounting and/or verification of information pertaining to jewelry over a network according to an exemplary embodiment of a method and/or system of the present invention. Server bank 501 may include multiple server computers (“servers”) for processing information requests between client computers and/or wireless devices such as 502 (e.g., purchasers' computers) and vendor management computers and/or wireless devices such as 503 (e.g., sellers' computers) according to an exemplary embodiment of the present invention. Although FIG. 5 shows an exemplary computer server bank 501 to include three servers A, B, and C, any number of servers may be used.

Continuing with FIG. 5, the server bank 501 may be attached to a communication link (such as the Internet or an intranet) with multiple potential purchaser and seller locations 504-513. Although FIG. 5 shows an exemplary group of ten potential seller/purchaser locations 504-513, any number of potential seller/purchaser locations may be used.

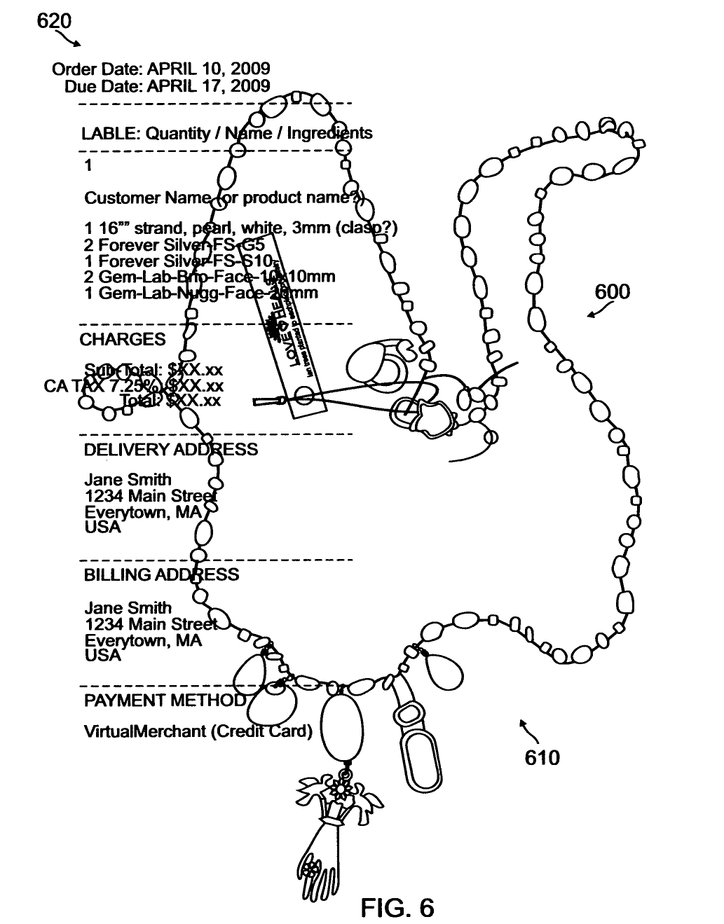

FIG. 6 shows an interface displayed by a host computer and/or a wireless device for executing a method and/or system according to one exemplary embodiment of the present invention. According to one exemplary embodiment of the present invention, an interface 600 is configured to enable the displaying of a jewelry design 610 and an information display 620 that is configured to provide, for example, information such as the date the item was ordered, when the product is due to be shipped to the customer, a detailed list of the jewelry components that are to be used to assemble a custom designed jewelry product and their corresponding technical codes (for example SKU's) and quantities, the customer's name and/or address, the address to which the product is to be shipped, the payment method and a screenshot image of the design. According to one exemplary embodiment of the present invention, the information (e.g., jewelry design 610 and/or information display 620) displayed by the interface 600 can be used by an individual and/or machine to recreate the customer's design.

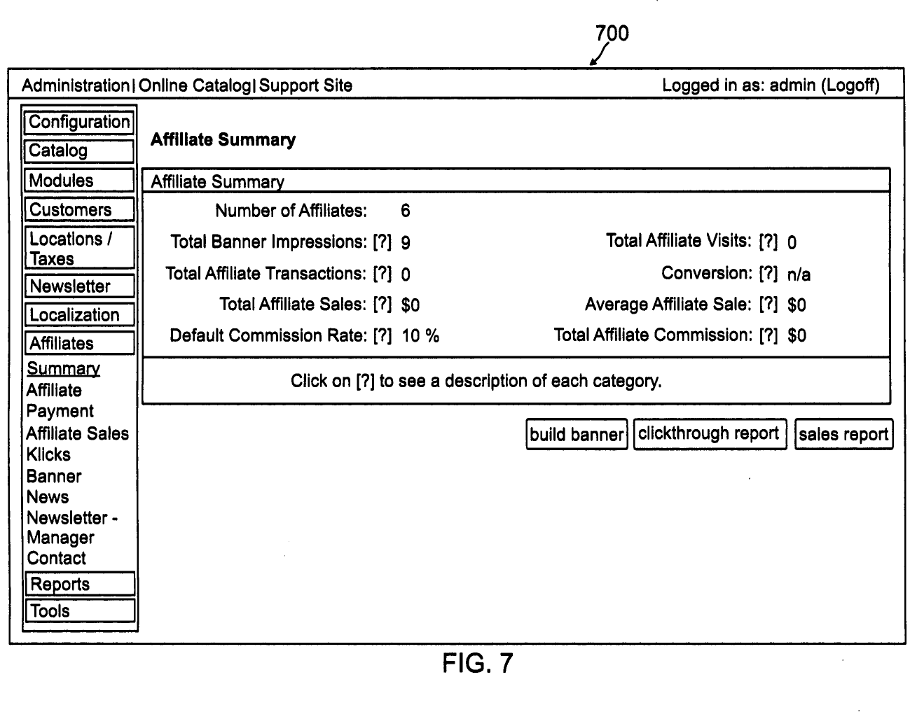

FIG. 7 shows an interface 700 displayed by a host computer and/or a wireless device for executing a method and/or system according to one exemplary embodiment of the present invention. According to one exemplary embodiment of the present invention, interface 700 is configured to enable the displaying of a web based affiliate management program accessible by affiliates who are interested in traffic pertaining to a custom design jewelry application over a network. According to one exemplary embodiment of the present invention, interface 700 is configured to enable the displaying of a management program configured to enable an affiliate to view reports containing information such as on how much traffic they have driven to a designer's application, how much of this traffic has been converted into transactions and sales including information pertaining to commissions derived from sales, the affiliate's commission rate, conversion ratios from total traffic to purchases, average affiliate sales, and total affiliate commissions. According to one exemplary embodiment of the present invention, screen display displays modules that may be turned on or off, depending on the selections made by a master administrator that determines what information each affiliate is capable of viewing and managing for each of their accounts.

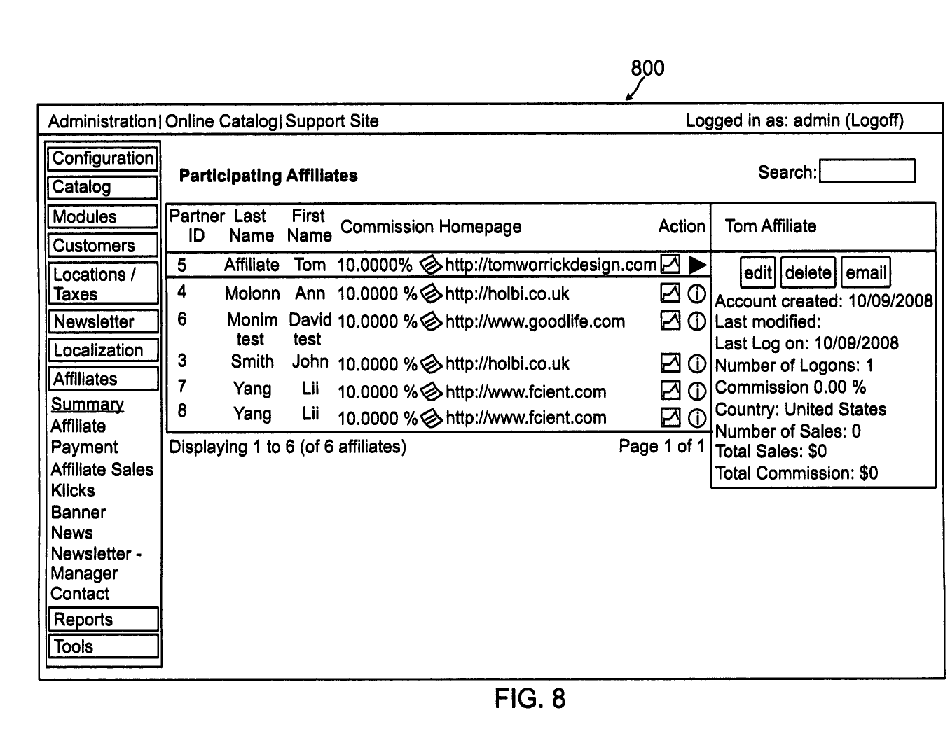

FIG. 8 shows an Interface 800 displayed by a host computer and/or a wireless device for executing a method and/or system according to one exemplary embodiment of the present invention. According to one exemplary embodiment of the present invention, interface 800 is configured to enable the displaying of a master administrator report that is capable of displaying all of the affiliates for the designer jewelry application. According to one exemplary embodiment of the present invention, Interface 800 displays a master administrator report that is capable of displaying the affiliates' names, commission rates, activity and sales as well as the location of affiliates who are driving traffic to the network based custom design jewelry application. According to one exemplary embodiment of the present invention, Interface 800 is configured to enable the master administrator to be able to click on the name of any of the displayed affiliates to obtain a more detailed display of each affiliate's activities, the amount of traffic referred, the amount of their traffic that converted into sales and other attributes of the affiliates.

According to one exemplary embodiment of the present invention, interface 800 is configured to enable the displaying of a password protected display configured to enable a user (such as an administrator or sub administrator) to: view all affiliates, view and/or manage their respective commission rates, view their transaction history and their payment history. According to one exemplary embodiment of the present invention, interface 800 is configured to enable the displaying of a password protected display that is configured to enable the displaying of the required payment account information needed to pay the affiliate and/or customer for referring customer(s) who complete purchases of Custom Jewelry Design Applications. According to one exemplary embodiment of the present invention, interface 800 is configured to enable the displaying of a networked form configured to be accessible via a browser or mobile device to allow an affiliate to sign up and/or create an account. According to one exemplary embodiment of the present invention, interface 800 is configured to enable the displaying of a password protected administrator interface in the content management system that is configured to be accessible via a browser or mobile device. According to one exemplary embodiment of the present invention, a password protected administrator interface is configured to enable a user (such as an administrator or sub administrator) to produce reports of which jewelry components or finished custom jewelry designs are most popular in the Custom Jewelry Design Application. For example, the administrator (or sub administrator) can produce reports that show which items were most and/or least viewed and/or which items were most/least purchased. According to one exemplary embodiment of the present invention, interface 800 is the part of a software application that is configured to enable a user to view and interact with (including but not limited to text menus, checkboxes, clickable images and drag-and-drop approaches). According to one exemplary embodiment of the present invention, interface 800 is configured to enable a user to interact with tools (such as buy, save, share, rotate, zoom, filter, taxonomy displays) and bitmap images (and/or photographs with a transparent layer) representing jewelry components. According to one exemplary embodiment of the present invention, a design stage is configured to enable a user to be able to select and manipulate bitmap images (and/or photographs with a transparent layer) each of which represents at least one jewelry component, in order to design a custom jewelry design that can in turn be assembled into a finished product that contains the jewelry component(s).

According to one exemplary embodiment of the present invention, interface 800 is the part of a software application that is configured to enable a user to view and to interact with (including but not limited to text menus, checkboxes, clickable images, drag-and-drop approaches). According to one exemplary embodiment of the present invention, interface 800 is configured to enable a user to interact with a design stage, tools (such as buy, save, share, rotate, zoom, filter, taxonomy displays) and bitmap images (and/or photographs with a transparent layer) representing jewelry components to design, share, save and purchase custom jewelry designs. According to one exemplary embodiment of the present invention, the design stage is configured to enable a user to be able to select and manipulate bitmap images (and/or photographs with a transparent layer) representing jewelry components so that they are able to build a custom jewelry design.

According to one exemplary embodiment of the present invention, interface 800 is the part of a software application that a user can view and interact with (including but not limited to text menus, checkboxes, clickable images, drag-and-drop approaches) over a network. According to one exemplary embodiment of the present invention, interface 800 is configured to enable a user to interact with uncompressed and compressed bitmap image (and/or photograph(s) with a transparent layer) representing jewelry components which are manipulated to design, share, save and purchase custom jewelry designs.

According to one exemplary embodiment of the present invention, interface 800 is a Flash application that is configured to enable a user to view and interact with (including but not limited to text menus, checkboxes, clickable images, drag-and-drop approaches) over a network. According to one exemplary embodiment of the present invention, interface 800 is configured to enable a user to be able to interact with uncompressed and compressed bitmap image (and/or photograph(s) with a transparent layer) representing jewelry components which are manipulated to design, share, save and buy custom jewelry designs.

According to one exemplary embodiment of the present invention, interface 800 is a Flash application mixed with other web elements (for example HTML, CSS, java and JavaScript), that is configured to enable a user to view and interact with (including but not limited to text menus, checkboxes, clickable images and drag-and-drop approaches) over a network. According to one exemplary embodiment of the present invention, interface 800 is configured to enable a user to interact with uncompressed and compressed BITMAP image (and/or photograph(s) with a transparent layer) representing jewelry components which are manipulated to design, share, save and/or purchase custom jewelry designs.

According to one exemplary embodiment of the present invention, interface 800 is a JAVA application that is configured to enable a user to view and interact with (including but not limited to text menus, checkboxes, clickable images and drag-and-drop approaches) over a network. According to one exemplary embodiment of the present invention, interface 800 is configured to enable a user to interact with uncompressed and compressed BITMAP image (and/or photograph(s) with a transparent layer) representing jewelry components which are manipulated to design, share, save and/or purchase custom jewelry designs.

According to one exemplary embodiment of the present invention, interface 800 is engineered with Objective C and configured to enable a user to view and interact with (including but not limited to text menus, checkboxes, clickable images and drag-and-drop approaches) over a network. According to one exemplary embodiment of the present invention, interface 800 is configured to enable a user to interact with uncompressed and compressed BITMAP image (and/or photograph(s) with a transparent layer) representing jewelry components which are configured to enable them to be manipulated for the purpose of designing, sharing, saving and/or purchasing custom jewelry designs.

According to one exemplary embodiment of the present invention, interface 800 is engineered with C and configured to enable a user to view and interact with (including but not limited to text menus, checkboxes, clickable images and drag-and-drop approaches) over a network. According to one exemplary embodiment of the present invention, Interface 800 is configured to enable a user to interact with uncompressed and compressed BITMAP image (and/or photograph(s) with a transparent layer) representing jewelry components which are capable of being manipulated to design, share, save and/or purchase custom jewelry designs.

According to one exemplary embodiment of the present invention, interface 800 is engineered with C++ and configured to enable a user to view and interact with (including but not limited to text menus, checkboxes, clickable images and drag-and-drop approaches) over a network. According to one exemplary embodiment of the present invention, interface 800 is configured to enable a user to interact with uncompressed and compressed bitmap image(s) (and/or photograph(s) with a transparent layer) representing jewelry components which are configured to enable them to be manipulated for the purpose of designing, sharing, saving and/or purchasing custom jewelry designs

According to one exemplary embodiment of the present invention, interface 800 is a JAVA application mixed with other web elements (for example HTML, CSS, java and JavaScript), configured to enable a user to view and interact with (including but not limited to text menus, checkboxes, clickable images and drag-and-drop approaches). According to one exemplary embodiment of the present invention, interface 800 is configured to enable a user to interact with uncompressed and compressed BITMAP image (and/or photograph(s) with a transparent layer) representing jewelry components which are configured to enable them being manipulated for the purpose of designing, sharing, saving and/or purchasing custom jewelry designs.

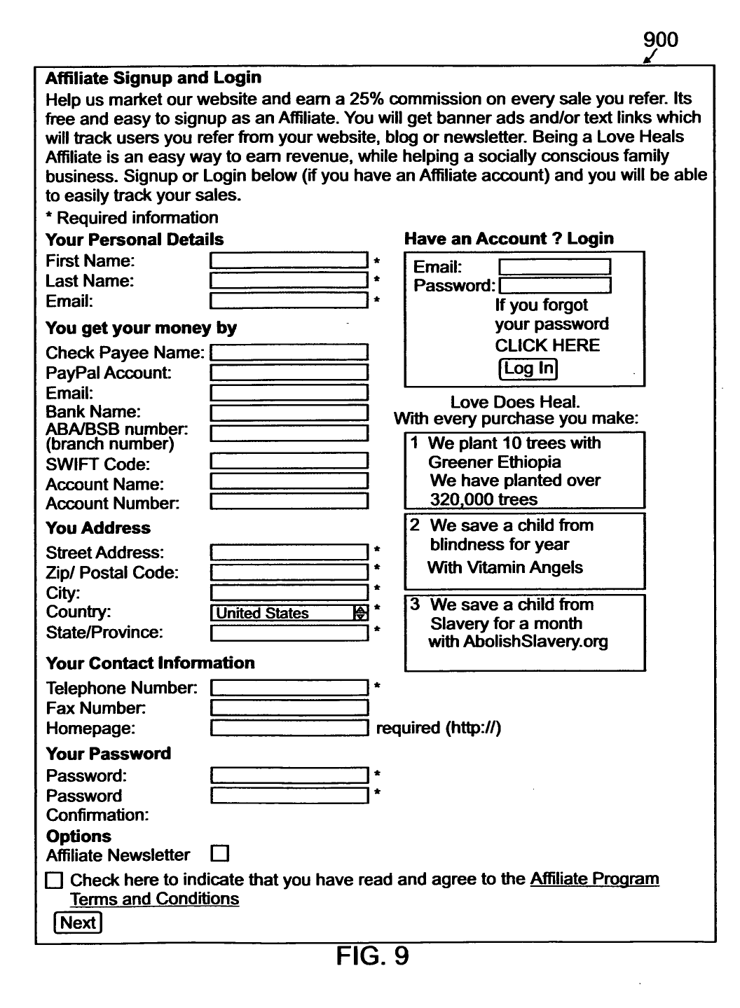

FIG. 9 shows an interface 900 displayed by a host computer and/or a wireless device for executing a method and/or system according to one exemplary embodiment of the present invention. According to exemplary one embodiment of the present invention, interface 900 is configured to enable the displaying of information pertaining to how prospective affiliates of the custom jewelry application are able to sign up and create accounts via a network connection. According to one exemplary embodiment of the present invention, interface 900 is configured to enable the displaying of a password protected administrator interface in the content management system that is configured to enable it to be accessible via a browser and/or mobile device or kiosk. According to one exemplary embodiment of the present invention, a password protected administrator interface is configured to enable a user (such as an administrator or sub administrator) to be able to create and/or manage new and/or existing jewelry components, which are configured to enable them being stored in a database and loaded into the interface of the Custom Jewelry Design Application. According to one exemplary embodiment of the present invention, a password protected administrator interface is configured to enable the displaying of information such as: wholesale and retail prices, the number of items that are available in an inventory, bitmap images (and/or photographs with a transparent layer) representing jewelry components and/or jewelry product designs, thumbnail images of jewelry product designs, and a description and/or list of the features of the finished products based on the jewelry product designs. According to one exemplary embodiment of the present invention, a password protected administrator interface is configured to enable it to access data stored in a database that is managed in a content management system and loaded into an interface of a Custom Jewelry Design Application.

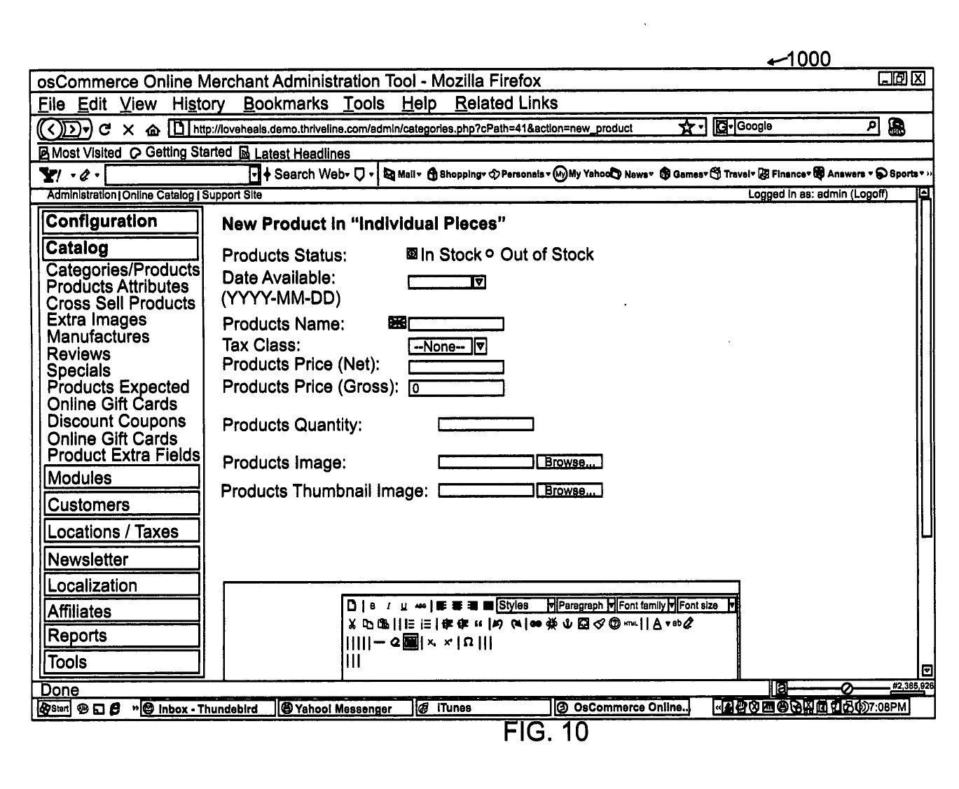

FIG. 10 shows an interface 1000 being displayed by a host computer and/or a wireless device for executing a method and/or system according to one exemplary embodiment of the present invention. According to one exemplary embodiment of the present invention, interface 1000 is configured to enable an administrator to log onto a content management system of the custom design jewelry application and to manage jewelry components, jewelry product designs and finish products based on the jewelry product designs. According to one exemplary embodiment of the present invention, interface 1000 is configured to enable a user (such as an administrator) to log onto a content management system of the custom design jewelry application which is configured to enable the enable the user (such as an administrator) to create a new jewelry component, to select whether the jewelry component is in stock or out of stock, to select a date in which the jewelry component is to be made available to users, to select a name for each jewelry component, to enter a retail price (e.g. a net price) for the jewelry component, to enter a wholesale price for the jewelry component (e.g. a gross price), to enter a quantity of available jewelry components, to upload one or more bitmap images (and/or photograph(s) with a transparent layer) representing jewelry components (which may or may not be transparent), to upload one or more thumbnail image(s) of a product jewelry Component (which may or may not be transparent), and to write a detailed description or key features of each jewelry component. According to one exemplary embodiment of the present invention, interface 1000 is configured to enable an administrator to be able to enter one or more content tags that users may search or filter through with which to find jewelry components. According to one exemplary embodiment of the present invention, a database is configured to enable the storing of information entered using a jewelry component creation module.

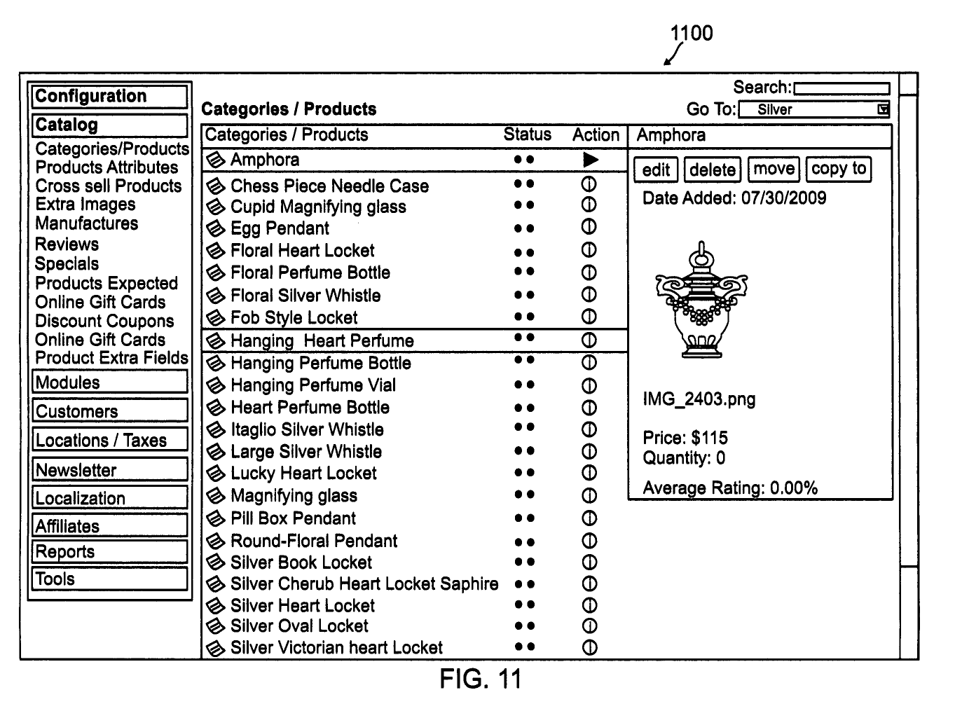

FIG. 11 shows an interface 1100 displayed by a host computer and/or a wireless device for executing a method and/or system according to one exemplary embodiment of the present invention. According to one exemplary embodiment of the present invention, interface 1100 is configured to enable the displaying of information, such as data arranged in categories and an overview of the categories of jewelry components, jewelry designs and/or jewelry products, to a user (such as an administrator of the custom jewelry application within the content management system). According to one exemplary embodiment of the present invention, interface 1100 is configured to enable the displaying of information which allows an administrator to highlight or select any jewelry component or jewelry design or finished product based on either the jewelry design(s) or the jewelry component(s) in a database, to see an overview, detailed view (e.g. as shown on the right side of FIG. 11) or to click a displayed button that causes a more detailed view to be displayed for example to provide an administrator with the capability of further editing or manipulating the component jewelry design. According to one exemplary embodiment of the present invention, interface 1100 is configured to enable the displaying of an interface that is capable of being manipulated by an Administrator, for example by toggling the view of the interface, to change the view from, for example from viewing jewelry components, to viewing jewelry designs, to viewing finished products based on jewelry designs that users have created. According to one exemplary embodiment of the present invention, interface 1100 is configured to enable the displaying of (e.g. by an administrator) information that can be edited and/or deleted, such as designs created by users, the number of times a design has been viewed and purchased, tags pertaining to a design that have been entered, and the price of each design. According to one exemplary embodiment of the present invention, interface 1100 is configured to enable user(s) to enter tags on individual jewelry components, jewelry designs and/or finished products.

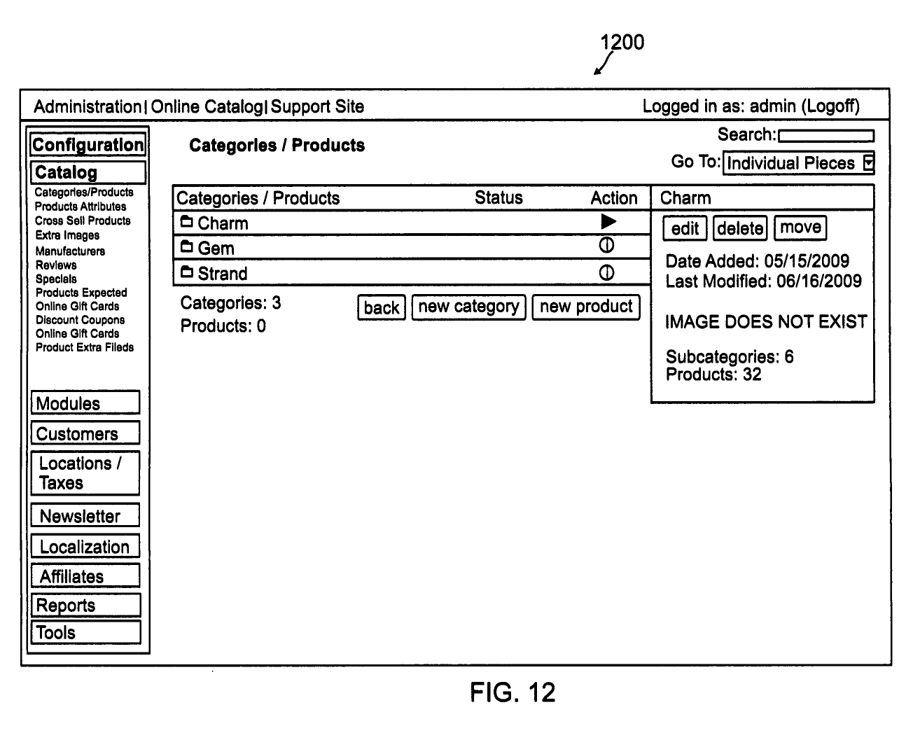

FIG. 12 shows an interface 1200 configured to enable the displaying by a host computer and/or a wireless device for executing a method and/or system according to one exemplary embodiment of the present invention. According to one exemplary embodiment of the present invention, interface 1200 is configured to enable the displaying of information that allows an administrator to view a taxonomy of jewelry components' categories in the content management system. According to one exemplary embodiment of the present invention, interface 1200 is configured to enable the editing of information stored in the database, which in turn modifies the category options of jewelry components available to end users of the Custom Jewelry Design Application and from this displayed category view a user (such as an administrator) can edit, add and delete categories in the taxonomy. According to one exemplary embodiment of the present invention, interface 1200 is configured to enable a user, such as an administrator, to add, edit and delete jewelry components that belong in an individual category and can create as many layers of sub categories as desired to allow for very specific types of jewelry components to be accessed by the end user.

According to one exemplary embodiment of the present invention, interface 1200 is configured to enable the displaying of a password protected administrator interface, which is configured to enable a user (such as an administrator or sub administrator) to the create and/or change information stored in folders to change a taxonomy. According to one exemplary embodiment of the present invention, interface 1200 is configured to enable the displaying of a password protected administrator interface that is configured to enable a user (such as an administrator or sub administrator) to be able to view master folders of “charms”, “gems” and “strands,” and with each folder there may exist subfolders containing qualities by which a user can filter and sort jewelry components to get information about the exact items that they want to use in a custom jewelry design.

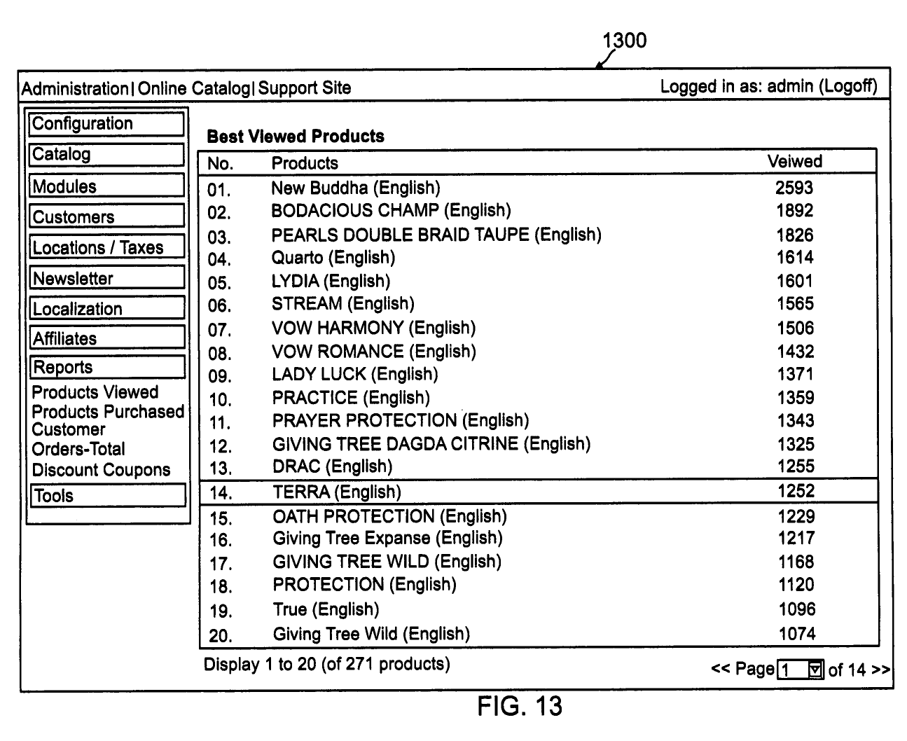

FIG. 13 shows an interface 1300 displayed by a host computer and/or a wireless device for executing a method and/or system according to one exemplary embodiment of the present invention. According to one exemplary embodiment of the present invention, interface 1300 is configured to enable the displaying of information, such as how many times a specific jewelry component, a finished design and/or a product based on a finished design have been viewed, for example by an administrator within the content management system. According to one exemplary embodiment of the present invention, interface 1300 is configured to enable the displaying of information capable of being edited, highlighted and/or selected, such as but not limited to a jewelry component, a finished design and/or a product based on a finished design, which allows for a more detailed view whereby a user (such as an administrator) is capable of highlighting and/or selecting any jewelry component in a database, to see an overview detailed view (shown on right side of FIG. 11), or to click in for a more detailed view where the user (such as an administrator) can further edit and/or manipulate the jewelry component. According to one exemplary embodiment of the present invention, interface 1300 is configured to enable the displaying of information capable of being edited, highlighted and/or selected and which allows for a more detailed view to be displayed to allow for example an administrator to further edit or manipulate a jewelry component and/or jewelry component design. According to one exemplary embodiment of the present invention, interface 1300 is configured to enable the displaying of jewelry components, finished designs that users have created, and products based on finished designs, the view of which can be toggled through, and if the viewer (e.g. an administrator) toggles the view, then the viewer is able to see designs that users of the custom design jewelry application have created. According to one exemplary embodiment of the present invention, interface 1300 is configured to enable a user to view designs created by users, and the number of times a design has been viewed and/or purchased, the tags that have been entered about the design, and can see the price of the design and can edit or delete the designs.

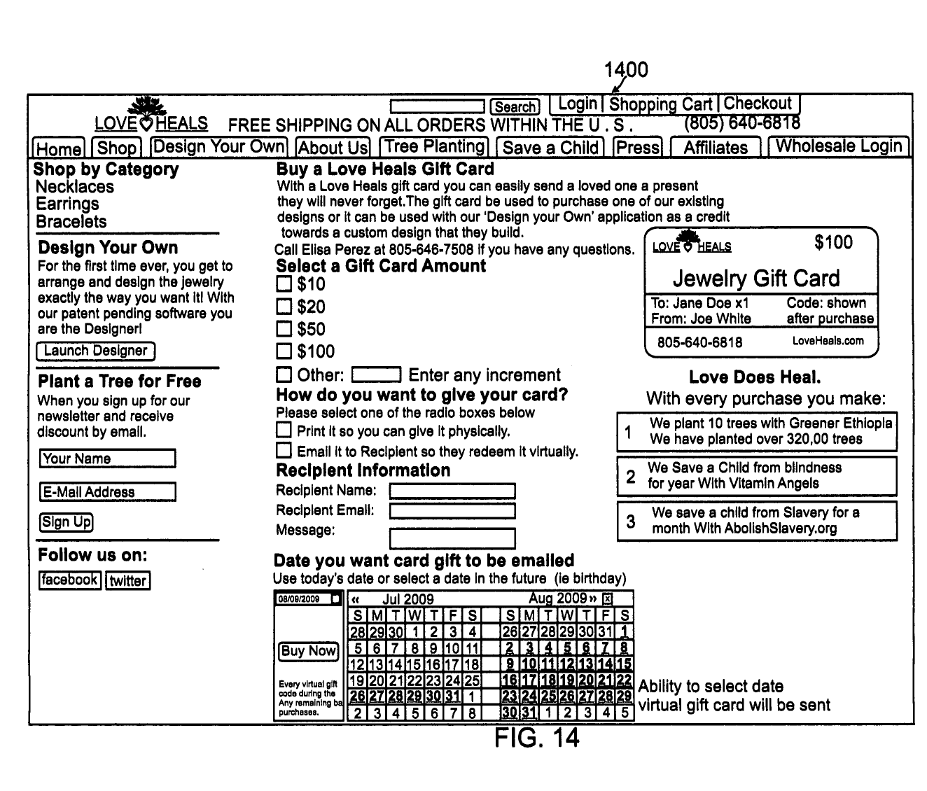

FIG. 14 shows an interface 1400 displayed by a host computer and/or a wireless device for executing a method and/or system according to one exemplary embodiment of the present invention. According to one exemplary embodiment of the present invention, interface 1400 is configured to enable the displaying of a virtual gift card that be purchased by users to give as gifts to friends or family for use with the Custom Jewelry Design Application. According to one exemplary embodiment of the present invention, interface 1400 is configured to enable a user to be able to select preset amounts of credit to apply to the gift card or enter a custom amount and as the user populates the data fields for the gift card to the custom design jewelry application, the corresponding data on the gift card is dynamically changed. According to one exemplary embodiment of the present invention, interface 1400 is configured to enable a user to print an image of the gift card and/or have it e-mailed to the recipient and if the user selects to have it mailed, then the user is able to select the date desired to have the gift card for Custom Jewelry Design Application e-mailed.

According to one exemplary embodiment of the present invention, interface 1400 is configured to enable the displaying of a gift card that a user is able to purchase for the Custom Jewelry Design Application. According to one embodiment of the present invention, interface 1400 is configured to enable the displaying of an image depicting a gift card, whereby a user is able to purchase a gift card for the Custom Jewelry Design Application, in which the gift card has a pre-determined amount or a manually entered amount. According to one exemplary embodiment of the present invention, interface 1400 is configured to enable a user to select whether they want to print a gift card or have it sent to the person to whom they are giving it. According to one exemplary embodiment of the present invention, if a user selects to have a gift card sent, then the user is able to select a date that they want the gift card to be sent for example to the Custom Jewelry Design Application (e.g., for a person's birthday). According to one exemplary embodiment of the present invention, when a user enters information about himself or herself as well as information about the recipient to whom the gift card is being sent, the image of the gift card changes dynamically to include the pertinent data. According to one exemplary embodiment of the present invention, when the user finishes purchasing a gift card, a unique gift code ID is generated in the database which is sent to both the user and the recipient, with which the recipient can use to redeem the gift card with the Custom Jewelry Design Application.

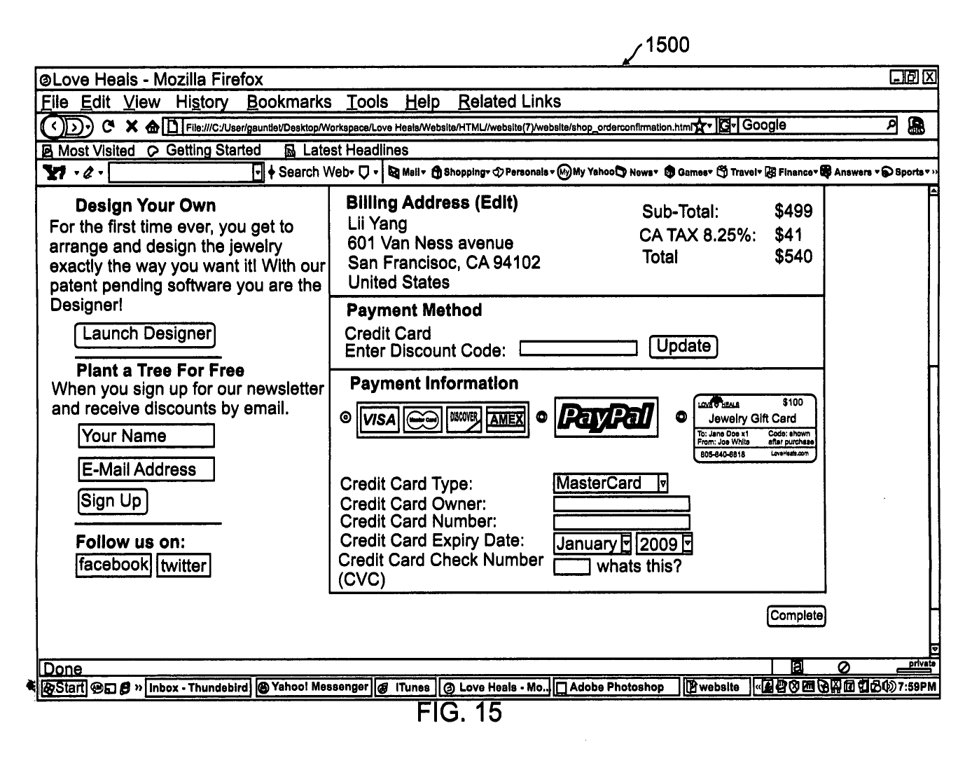

FIG. 15 shows an interface 1500 displayed by a host computer and/or a wireless device for executing a method and/or system according to one exemplary embodiment of the present invention. According to one embodiment of the present invention, interface 1500 is configured to enable the displaying of a checkout process for the Custom Jewelry Design Application. According to one exemplary embodiment of the present invention, interface 1500 is configured to enable the displaying the image(s) of the design(s) throughout the checkout process so a user can see the user's design(s) as the user completes checkout. According to one exemplary embodiment of the present invention, interface 1500 is configured to enable a user to be able to click on the image(s) of a design(s) to view it larger or further edit before the purchase is completed of the product represented by the design.

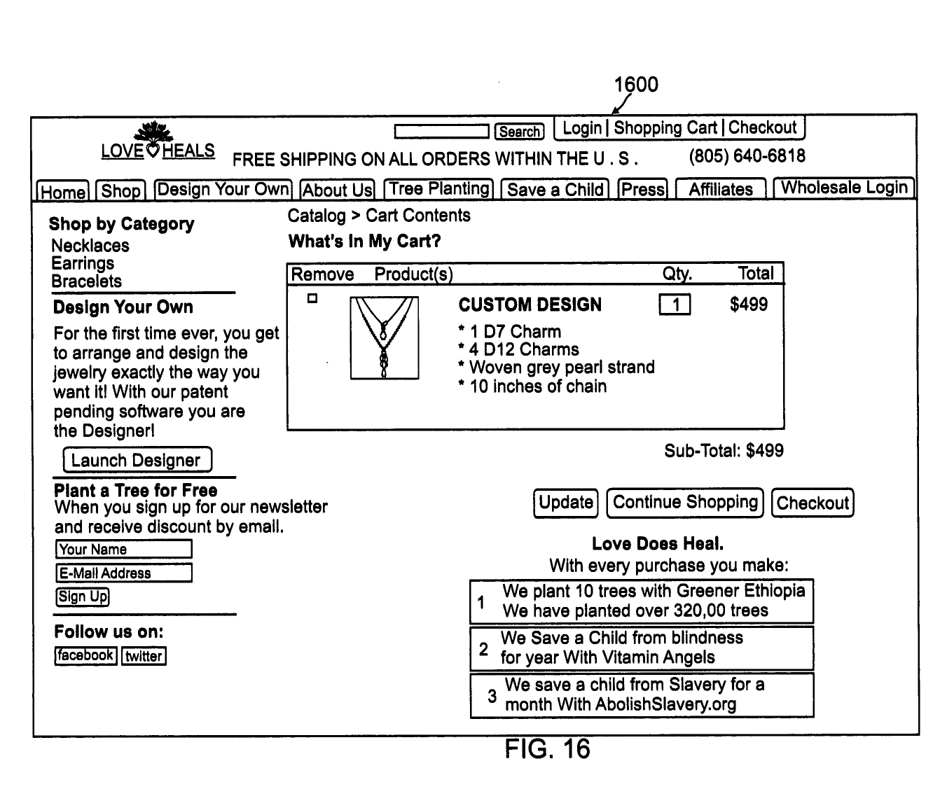

FIG. 16 shows an interface 1600 displayed by a host computer and/or a wireless device for executing a method and/or system according to one exemplary embodiment of the present invention. According to one exemplary embodiment of the present invention, interface 1600 is configured to enable the displaying of a checkout process for the Custom Jewelry Design Application. According to one exemplary embodiment of the present invention, interface 1600 is configured to enable the displaying of the image(s) of the user(s) design(s) throughout their checkout process so that user(s) can see the user's design(s) as they complete checkout. According to one exemplary embodiment of the present invention, interface 1600 is configured to enable a user to click on the image(s) of the design(s) to view the design(s) larger or to further edit the design(s) before purchase is completed of the product represented by the design. According to one exemplary embodiment of the present invention, interface 1600 is configured to enable displaying of a bitmap image (and/or photograph(s) with a transparent layer) of a final design that a user has created and sent over the e-commerce system so that the user can see an image of the product represented by the design that the user is purchasing through the checkout process. According to one exemplary embodiment of the present invention, interface 1600 is configured to enable displaying of an image depicting an e-mail and/or mobile system message that is generated when a user shares a design with a friend in which a unique URL link (or hyperlinked button/image) is created for the design created by the user so that the friend is able to click on the unique URL (or hyperlinked button/image) to for example: create the design the user made, purchase the design as is, further edit the design, and/or purchase a product represented by the design.

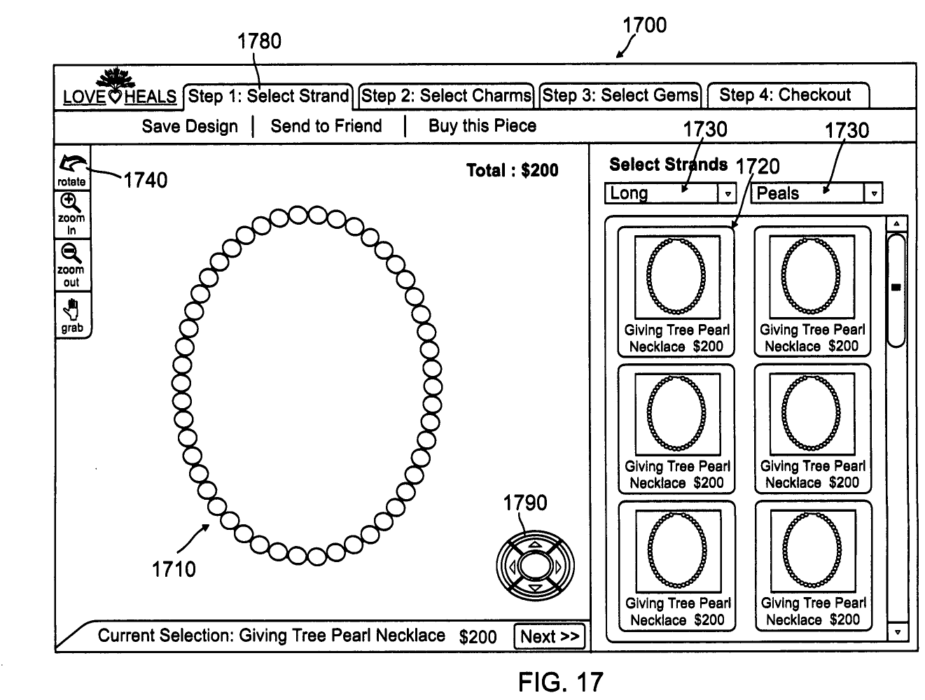

FIG. 17 shows an interface 1700 displayed by a host computer and/or a wireless device for executing a method and/or system according to one exemplary embodiment of the present invention. According to one exemplary embodiment of the present invention, interface 1700 is configured to enable displaying of a user interface of the Custom Jewelry Design Application. According to one exemplary embodiment of the present invention, interface 1700 is configured to enable the displaying of a design stage 1710 where a piece of jewelry can be visualized. According to one exemplary embodiment of the present invention, interface 1700 is configured to enable the displaying of an elements tray 1720 capable of displaying jewelry components from the taxonomy and/or thumbnail images of jewelry. According to one embodiment of the present invention, interface 1700 is configured to enable the displaying of a Custom Jewelry Design Application, which may or may not have a design stage 1710 and may or may not have an elements tray 1720 as they may be located in other parts of the user interface and/or be integrated into other functionality, designs and/or feature sets available to the end user. According to one exemplary embodiment of the present invention, interface 1700 is configured to enable the displaying of a suite of tools that the end user is able to use which will enable the user to rotate, zoom in, zoom out, select and manipulate various bitmap images (and/or photographs with a transparent layer) representing jewelry components which the end user wishes to use for their custom jewelry design. According to one exemplary embodiment of the present invention, interface 1700 is configured to enable displaying of a user interface that is configured to allow a user to select and navigate different areas of the jewelry component taxonomy and database by selecting from drop down menus 1730. According to one exemplary embodiment of the present invention, interface 1700 is configured to enable an end user to be able to use a search field, radio buttons, ratings, reviews, a most popular filter, a most expensive filter, a least expensive filter and selection mechanisms to browse jewelry component which can be used to create a custom jewelry design. According to one exemplary embodiment of the present invention, interface 1700 is configured to enable a user to save to a list of favorites jewelry components, jewelry designs and/or products based on jewelry designs which the user wants to be able to access in the future. According to one exemplary embodiment of the present invention, interface 1700 is configured to enable a user to share and publish the user's designs with others using a social network (such as Facebook, Twitter, Bebo, etc). According to one exemplary embodiment of the present invention, when a user selects to share a design, an image of the design and/or a unique URL link (or hyperlinked button/image) is published, which launches the Custom Jewelry Design Application when clicked and/or allows the user to return back to the user's design.

According to one exemplary embodiment of the present invention, interface 1700 is configured to enable the displaying of a bitmap image (and/or photograph(s) with a transparent layer) representing one or more jewelry components obtained from a database. According to one exemplary embodiment of the present invention, a bitmap image (and/or photograph(s)) representing jewelry components) is displayed on a transparent layer, so that one or more bitmap images (or photograph(s) with a transparent layer) representing jewelry components can be layered above or below it. According to one exemplary embodiment of the present invention, elements tray 1720 is configured to enable the display of thumbnail images. According to one embodiment of the present invention, interface 1700 is configured to enable the displaying of a total price, which shows the total cost for all the jewelry components displayed on the design stage 1710. According to one exemplary embodiment of the present invention, interface 1700 is configured to enable it to be accessible and utilized from at least one of the following: a browser window, a client application sitting on a local machine, a kiosk at a retail location, a mobile device, a smart phone (such as an iphone), and a social network (such as Facebook). According to one exemplary embodiment of the present invention, interface 1700 is configured to enable the displaying of bitmap images (and/or photograph(s) with a transparent layer) representing jewelry components obtained from a database which are indexed, loaded and/or factored into memory, with the factored (and/or indexed/loaded) bitmap images (and/or photograph(s) with a transparent layer) representing jewelry components from the database allowing for display of the jewelry component taxonomies and categories from the database to be displayed in the interface 1700. According to one exemplary embodiment of the present invention, database driven bitmap images (and/or photographs with a transparent layer) representing jewelry components can be manipulated to design, save, buy or share custom jewelry designs. According to one exemplary embodiment of the present invention, interface 1700 is configured to enable the displaying of bitmap images (and/or photograph(s) with a transparent layer) representing jewelry components obtained from a database which are indexed, loaded and/or factored into memory and loaded into Flash, with the factored (or indexed/loaded) bitmap images (and/or photograph(s) with a transparent layer) representing components from the database and to allow for the display of the jewelry component taxonomies and categories from the database to be displayed in Flash; and these bitmap images (and/or photograph(s) with a transparent layer) representing jewelry components from the database, can then be manipulated to design, save, buy or share custom jewelry designs. According to one exemplary embodiment of the present invention, interface 1700 is configured to enable the displaying of bitmap images (and/or photograph(s) with a transparent layer) representing jewelry components obtained from a database which are indexed, loaded and/or factored into memory and loaded into Flash and may be present with other programmatic browser display tools (such as but not limited to, HTML, CSS, XML, Javascript); and the factored (or indexed/loaded) bitmap images (and/or photograph(s) with a transparent layer) representing components from the database, allow for displaying of the jewelry component taxonomies and categories from the database to be displayed in Flash (and may be present with other potential browser display languages); and these images (and/or photograph(s) with a transparent layer) representing jewelry components from the database can then be manipulated to design, save, buy or share custom jewelry designs. According to one embodiment of the present invention, interface 1700 is configured to enable the displaying of bitmap images (and/or photograph(s) with a transparent layer) representing jewelry components obtained from a database which are indexed, loaded and/or factored into memory and loaded into JAVA, with the factored (or indexed/loaded) bitmap images (and/or photograph(s) with a transparent layer) representing components from the database allowing for display of the jewelry component taxonomies and categories from the database to be displayed in JAVA; with these images (representing components) from the database, which can then be manipulated to design, save, buy or share custom jewelry designs. According to one exemplary embodiment of the present invention, interface 1700 is configured to enable the displaying of bitmap images (and/or photograph(s) with a transparent layer) representing jewelry components obtained from a database which are indexed (e.g. each indexed to a price), loaded and/or factored into memory, factored and loaded into JAVA and may be present with other programmatic browser display tools (such as but not limited to, HTML, CSS, XML, JavaScript, Flash) with the factored (or indexed/loaded) bitmap images (and/or photograph(s) with a transparent layer) representing jewelry components from the database allowing for display of the jewelry component taxonomies and categories from the database to be displayed in JAVA (and may be present with other potential programmatic browser display tools); with these bitmap images (and/or photographs with a transparent layer) representing jewelry components from the database, that can then be manipulated to design, save, buy or share custom jewelry designs.

According to one embodiment of the present invention interface 1700 is populated with jewelry components such as types of jewelry strands. According to one embodiment of the present invention, interface 1700 is configured to enable the displaying of scrolling members, which allow a user to sort through the jewelry components. According to one embodiment of the present invention, Interface 1700 is configured to display charms and gems which are capable of automatically rotating (in relationship to the strand), when they are placed on or near the desired strand. According to one embodiment of the present invention, interface 1700 is configured to enable the providing an invisible template track for each of the strand lengths (such as 16 inches, 24 inches and 36 inches). According to one embodiment of the present invention, interface 1700 is configured to enable it being controlled by a dynamic product taxonomy of jewelry components and bitmap images (and/or photograph(s) with a transparent layer) representing jewelry components that are loaded from a database and administered from a content management system. According to one exemplary embodiment of the present invention, when a user selects a bitmap image (and/or photograph with a transparent layer) representing a jewelry component, a highlighted state (or message alert) will appear around the item, to provide visual recognition to the user that the item has been selected. According to one exemplary embodiment of the present invention, when an element is selected, but is not currently in stock in inventory, the item will have a highlighted state (or text/graphic which indicates its out-of-stock status), and a message will be provided to the user (such as “out of stock”), and a pop-up message will display (such as “There are items in this design that are currently out of stock. Please replace these items before checking out.”)

According to one exemplary embodiment of the present invention, interface 1700 is configured to be capable of displaying tools that can be used by a user of the system and/or method. According to one exemplary embodiment of the present invention, interface 1700 is configured to include a hand (and/or arrow/selector) tool. According to one exemplary embodiment of the present invention, interface 1700 is configured to include a hand tool (and/or arrow/selector), which is a default tool when the application begins. According to one exemplary embodiment of the present invention, a user can click on a hand (and/or arrow/selector) tool using a mouse button. According to one exemplary embodiment of the present invention, a user is able to drag, move or rotate a desired bitmap image (and/or photograph representing jewelry component(s)) with the hand (and/or arrow/selector) tool, by holding the mouse button down, taking the desired action, and then letting go of the mouse mutton (for the purpose of designing, sharing or purchasing a custom jewelry design).

According to one exemplary embodiment of the present invention, interface 1700 is configured to enable the displaying of a zoom-in tool, which a user can activate (for example by clicking on it) to magnify the view of any area upon which the user click activates on the display. According to one exemplary embodiment of the present invention, interface 1700 is configured to enable the displaying of a zoom-out tool, which a user can activate (for example by clicking on it) to lower the magnification of the view of any area upon which the user click activates on the display.

According to one exemplary embodiment of the present invention, interface 1700 is configured to enable the displaying of a rotation tool 1740. According to one exemplary embodiment of the present invention, interface 1700 is configured to enable the displaying of a rotation tool, which a user can activate (for example by clicking on it) to rotate any displayed item while the item is displayed on the Design Stage 1710. According to one exemplary embodiment of the present invention, after a user clicks on the rotation tool any item displayed on the Design Stage 1710 will display curved arrows on each corner of the item so that when a user clicks on the arrow the item's view will be rotated along the angle that corresponds to that arrow. According to one exemplary embodiment of the present invention, a user may select any jewelry component that is displayed on the Design

Stage 1710 and when this item is selected, the user can rotate the jewelry component manually with the mouse or keyboard to change the angle of the item in either a clock wise or counter clock wise direction. According to one exemplary embodiment of the present invention, interface 1700 is configured to enable a user to select a bitmap image (and/or photograph(s) with a transparent layer) of a jewelry component, and move it up a layer or down a layer so that it rests above or below other images of jewelry components which are displayed on the interface at the same time. According to one exemplary embodiment of the present invention, interface 1700 is configured to enable a user to select a bitmap image (and/or photographs with a transparent layer) of a jewelry component and move it to the very front layer of the jewelry design so it becomes displayed on top of everything else and/or move it to the very bottom so it is displayed under all other layers.

According to one exemplary embodiment of the present invention, interface 1700 is configured to enable the displaying of a design stage tool 1790, which a user can activate (for example by clicking on it) to move the view of the design stage 1710 up, down and/or side-to-side after the design stage 1710 is magnified using the zoom-in tool.

According to one exemplary embodiment of the present invention, interface 1700 is configured to enable a user to be able to rotate the bitmap image(s) (and/or photograph(s) with a transparent layer) representing jewelry component(s), to be able to zoom in 1750 and out 1760 of the design stage 1710, and to be able to select or deselect particular jewelry components. According to one exemplary embodiment of the present invention, Interface 1700 is configured to enable a user to be able to share a custom jewelry design, to save it and/or purchase it.

According to one exemplary embodiment of the present invention, interface 1700 is configured to display action buttons 1780 that can be activated by a user to save a design, to send a design to another individual (such as a friend on a social network), and/or to buy the jewelry piece that is represented by the design. According to one embodiment of the present invention, interface 1700 is configured to enable a user to engage an action button, which automatically generates an e-mail that is sent to the user that includes an image of the design (for example in .jpg format) and a custom URL (or button/image with link imbedded), linking back to the application; with the bitmap images (and/or photograph(s) with a transparent layer representing jewelry component(s), in the same location at the time the save, share or purchase function was initiated.

According to one exemplary embodiment of the present invention, Interface 1700 is configured to enable a user to engage an action button, which automatically generates an e-mail that is broadcast to multiple e-mail addresses (such as friends of the user on a social network) that includes a copy of the image of the design (for example in .jpg format) and a custom URL (or button/graphic with URL imbedded), linking back to the application with the bitmap images (and/or photographs with a transparent layer) representing jewelry component(s), in the same location at the time the save, share or purchase function was initiated.

According to one exemplary embodiment of the present invention, when a user engages a buy, purchase and/or checkout process of a desired custom jewelry design, a handshake is initiated with an e-commerce engine (including but not limited to a shopping cart, payment gateway and/or third party processor such as PayPal or Google) to transmit details such as (but not limited to) image(s), price corresponding to the total sum of jewelry component(s) use to create the custom jewelry design, which are represented by the bitmap image(s) (and/or photograph(s) with a transparent layer), technical specification, SKU/s, and unique URL (or hyperlinked button/image) to recreate the custom jewelry design. According to one exemplary embodiment of the present invention, interface 1700 is configured to enable the displaying of an image of the user's custom jewelry design throughout all (or part) of the checkout and e-commerce process and this image of the custom jewelry design may (or may not) include a button or link to reload the custom jewelry design for further editing before completing purchase.

According to one exemplary embodiment of the present invention, interface 1700 is configured to enable the displaying of a pre-loader screen each time the Custom Jewelry Design Application is being loaded on either the host computer and/or wireless device. According to one exemplary embodiment of the present invention, interface 1700 is configured to enable the displaying of a pre-loader screen displaying a logo, a graphic, an applet, a saying and/or a program. According to one exemplary embodiment of the present invention, interface 1700 is configured to enable it to be populated and/or managed using XML. According to one exemplary embodiment of the present invention, the system and/or method of the present invention is configured to enable stored sayings 606 (e.g., in some cases up to a total of ten sayings) to display on rotation (i.e., one of the sayings' displayed at a time).

According to one exemplary embodiment of the present invention, interface 1700 is configured to enable the displaying of a walk-through tutorial to a user when the Custom Jewelry Design Application begins. According to one exemplary embodiment of the present invention, interface 1700 is configured to enable a user to have the ability to close the tutorial at anytime and specifying that further tutorial prompts are not needed. According to one embodiment of the present invention, interface 1700 is configured to enable a user to have the ability to navigate the viewing of the tutorial screens by clicking on a “next” or “previous” button or by selecting to view specific text and/or video selections that are available demonstrating the use of the Custom Jewelry Design Application. According to one exemplary embodiment of the present invention, the tutorial will be populated and/or managed using XML, and/or a CMS system, database or txt files.

According to one exemplary embodiment of the present invention, interface 1700 is configured to enable the displaying of an image, an e-mail and/or a mobile system message sent to an administrator listing all the customer data of a user who purchased a custom design that can be used for the purpose of creating and shipping the design. According to one exemplary embodiment of the present invention, interface 1700 is configured to enable the displaying of an image that can be for example include an e-mail and/or a mobile message (for example txt), which contains one or more bitmap images (and/or photograph(s) with a transparent layer) representing the totality of the jewelry components that a user arranged to create a custom jewelry design. According to one exemplary embodiment of the present invention, interface 1700 is configured to enable the displaying of an image that can be for example include an e-mail and/or a mobile message (for example txt), which contains a detailed listing of the technical SKU numbers of each jewelry component used to create the design and quantity used.

According to one exemplary embodiment of the present invention, interface 1700 is configured to enable the displaying of a password protected wholesale login environment that is configured to enable wholesale customers to be able to create an account or logon into an existing account where they are able to have access to wholesale pricing for the custom designs they make with the Custom Jewelry Design Application via a wholesale interface.

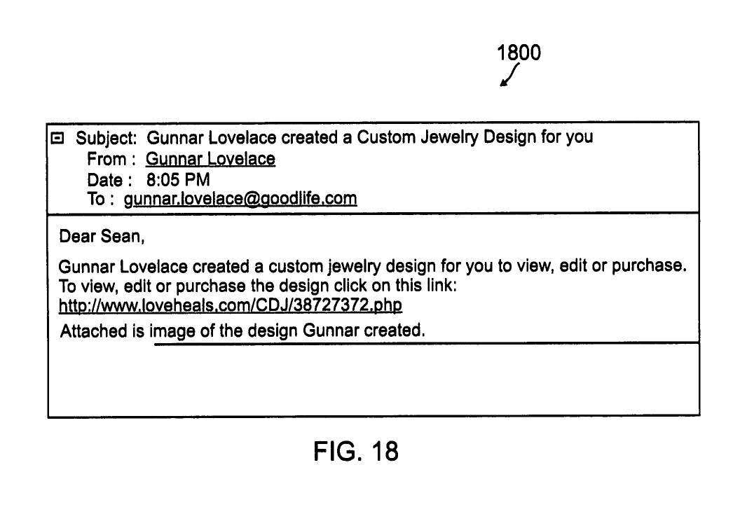

FIG. 18 shows an Interface 1800 displaying an example e-mail that is generated when a user sends a custom jewelry design to another person from the user interface according to an exemplary embodiment of the present invention. According to one exemplary embodiment of the present invention, interface 1800 displays an e-mail that is generated when a user sends a custom jewelry design to another person (for example to share it) from the user interface, which contains a unique URL link (or hyperlinked button/image) that can be clicked to view the design or launch the Custom Jewelry Design Application. According to one exemplary embodiment of the present invention, an image of a design may be attached or embedded into the e-mail. According to one exemplary embodiment of the present invention, a rich media e-mail can be sent as well, which enables the recipient(s) to click on the image itself, a button or link embedded in the rich media which will launch the design or Custom Jewelry Design Application.

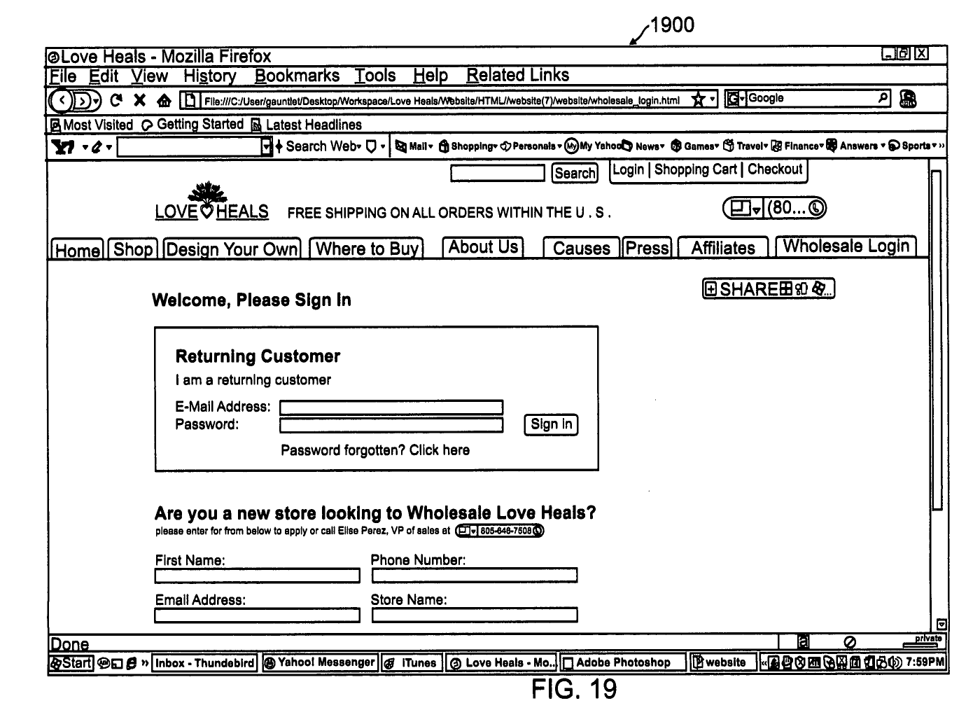

FIG. 19 shows an interface 1900 configured to enable users of wholesale accounts to the Custom Jewelry Design Application to access by logging in and/or creating an account according to one exemplary embodiment of the present invention. According to one exemplary embodiment of the present invention, with a wholesale account, a user is able to use the Custom Jewelry Design Application in which wholesale prices are indicated on each jewelry component, which the user can view during the creation of a design(s).

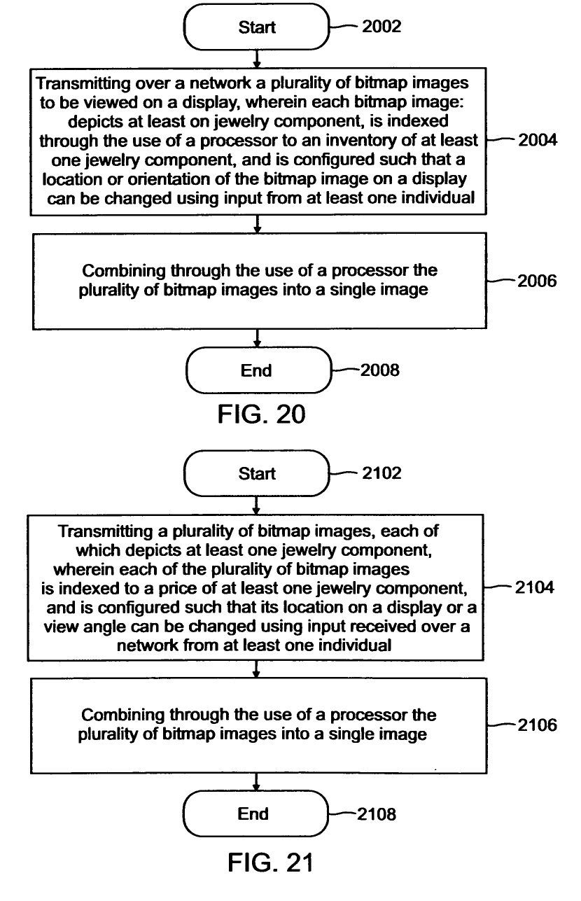

FIG. 20 shows a flow chart of an example of operation of one exemplary embodiment of a method for designing jewelry over a network. According to an exemplary embodiment of the present invention, some, all or none of the steps of the method can involve human interaction. According to an exemplary embodiment of the present invention, some, all or none of the steps of the method can be automated. According to an exemplary embodiment of the present invention, a processor implemented method for designing jewelry over a network starts at 2002 where a plurality of BITMAP images are transmitted over a network to be viewed on a display, wherein each BITMAP image depicts at least one jewelry component, is indexed through the use of a processor to an inventory of at least one jewelry component, and is configured such that a location or orientation of the BITMAP image on a display can be changed using input from at least one individual. According to an exemplary embodiment of the present invention, each of the plurality of bitmap images is configured such that a location of the image on an Interface display can be changed using input from at least one individual. According to an exemplary embodiment of the present invention, a location of the bitmap image on a display can be changed using input from several individuals (such as potential buyer and a potential seller collaborating on a piece of jewelry to be purchased). At step 2004, the plurality of BITMAP images are combined through the use of a processor into a single image. The method ends at 2008.

According to an exemplary embodiment of the present invention, one or more of the plurality of images (and/or photograph(s)) representing jewelry components comprises a transparent background. According to an exemplary embodiment of the present invention, each of the plurality of images (and/or photograph(s) with a transparent layer) depicts jewelry components, jewelry designs and/or products based on the jewelry designs. According to an exemplary embodiment of the present invention, a method and/or system is configured to enable the application of structure recognition to at least one image. According to an exemplary embodiment of the present invention, a method and/or system is configured to enable the application of structure recognition wherein the structure recognition includes at least one neural network. According to an exemplary embodiment of the present invention, a method and/or system is configured to enable displaying of a plurality of bitmap images (and/or photographs with a transparent layer) representing jewelry component(s) on a display, wherein the displaying includes the capability of changing the view of each the plurality of images. According to an exemplary embodiment of the present invention, a method and/or system is configured to enable the correlation (e.g. by indexing) through the use of a processor a price to each of the images. According to an exemplary embodiment of the present invention, a method and/or system of the present invention is configured to combine through the use of a processor the plurality of bitmap images (and/or photographs with a transparent layer) representing jewelry component(s) into a single image wherein the combining through the use of a processor the plurality of images into a single image includes transforming the single image into a two-dimensional image. According to an exemplary embodiment of the present invention, a method and/or system is configured to enable the displaying of three-dimensional images. According to an exemplary embodiment of the present invention, a method and/or system is configured to enable the displaying of bitmap images (and/or photographs with a transparent layer) representing jewelry component(s) that contain metadata that is capable of being used to implement the method and/or system. According to an exemplary embodiment of the present invention, a method and/or system is configured to enable displaying image(s) on a social network to at least one individual (such as a potential seller of the product and a potential purchaser of the product).

According to an exemplary embodiment of the present invention, a method and/or system of the present invention is configured to enable an individual using a web browser or a mobile device over a network to interact with an interface configured to be driven by at least one of Flash, Flex, Action Scripting, JAVA, PHP, ASP, .NET, C#, C++, C, Objective C, HTML, Python, Perl, Ruby and other programming languages for the sake of creating a visual representation of bitmap images (and/or photographs with a transparent layer) representing jewelry component(s) used for designing jewelry, that communicates with a database, content management system, server, social networks and/or e-commerce system for the purpose of creating a visual representation of images that are customizable, sharable, savable, capable of being manipulated and marketable.

According to an exemplary embodiment of the present invention, a method and/or system of the present invention includes an interface configured to enable an individual using a web browser or mobile device over a network to manipulate images (and/or photographs with a transparent layer) which represent jewelry components (including but not limited to charms, strands, gems, beads, etc) and/or jewelry designs and/or products of jewelry based on jewelry designs. According to an exemplary embodiment of the present invention, a method and/or system of the present invention includes an interface configured to enable an individual to filter bitmap images (and/or photographs with a transparent layer) which represent jewelry components, jewelry designs or a product based on a jewelry design of jewelry by type, size, cost, rating and inventory available, and the individual is able to click on any image to see a detailed view of it, additional photos, a detailed description and reviews. According to an exemplary embodiment of the present invention, a method and/or system of the present invention includes an interface 1700 configured to enable an individual to select or drag the bitmap images (and/or photographs with a transparent layer) which represents jewelry components in the database, onto a Design Stage 1710 where the user is able to manipulate the images together to build a custom designed piece of jewelry. According to an exemplary embodiment of the present invention, the bitmap images (and/or photographs) are configured to have solid backgrounds, transparent backgrounds or a combination of both depending on how they were loaded into the content management system. According to an exemplary embodiment of the present invention, in some instances the bitmap images (or photographs) are configured to have transparent backgrounds so that they can be layered on top of each other to create a more complicated custom jewelry design. According to an exemplary embodiment of the present invention, the bitmap images (and/or photographs with a transparent layer representing jewelry components), are configured to have a snap fit relationship so that they can be layered completely on top of each other, or partially on top of each other, and the images appear to snap together and/or snap together. According to an exemplary embodiment of the present invention, the design stage 1710 is configured to enable a user to be able zoom to in and out of the design stage 1710 (for example by using a zoom tool) which enables the user to see close up details and/or the entire jewelry design. According to an exemplary embodiment of the present invention, the images are configured to be able to be rotated and as the individual manipulates the image (for example by moving it using mouse clicks on a web browser), its coordinates and location are stored in a memory (e.g a database or the like) so that the custom design can be saved, shared, changed or purchased. According to an exemplary embodiment of the present invention, a layer manipulation control enables a user to bring selected image(s) forwards or backwards, to enable a specific jewelry component to be layered on top of another jewelry component. According to an exemplary embodiment of the present invention, in some cases the images (and/or photographs with a transparent layer) are configured to have transparent backgrounds which are placed on the Design Stage 1710.

According to an exemplary embodiment of the present invention, a method and/or system of the present invention includes an interface configured to enable the images displayed by the interface to be configured to enable an individual to save, share or purchase their custom jewelry design arrangement of images (and/or photographs with a transparent layer) representing jewelry components. According to an exemplary embodiment of the present invention, the system and/or method of the present invention is configured to enable an individual to save and/or share the individual's unique arrangement of bitmap images (and/or photographs with a transparent layer) representing jewelry components and the coordinates, placement, rotation and settings are saved into a database over a network so that the unique arrangement can be re-assembled at a later date. According to an exemplary embodiment of the present invention, the data of a jewelry design and exact arrangement coordinates are capable of being stored in an individual's profile in a database and in a Distinct URL link which is generated dynamically by the Interface, CMS and database.

According to an exemplary embodiment of the present invention, a method and/or system of the present invention, interface 1800 is configured to enable an individual to log into their account, or invite other users to view the individual's design, and the individual and/or the invited individual(s) are capable of seeing the custom design(s) that was saved or shared. According to an exemplary embodiment of the present invention, a distinct URL can also be generated in a saving or sharing process. According to an exemplary embodiment of the present invention, a method and/or system of the present invention includes an interface, CMS and database, all of which are configured to enable the sending an e-mail link with a distinct URL to an individual and/or to an invited individual(s). a method and/or system of the present invention includes an interface, CMS and database, all of which are configured to enable a user and/or invited individual(s) to be able to click on a distinct URL (or button/graphic) and have the interface launched, recreating the custom design. According to an exemplary embodiment of the present invention, when a custom jewelry design is saved or shared, a new image file of the combined bitmap images (and/or photographs with a transparent layer) representing jewelry components is capable of being created, and this new image will be a flattened layer of all the images the user assembled creating their design. According to an exemplary embodiment of the present invention, the image that is produced in the saving or sharing process may be in a TIFF, PNG, GIF, BMP, JPEG or any other bitmap format.

According to an exemplary embodiment of the present invention, interface 1700 is configured to enable more than one individual or user to manipulate bitmap images (and/or photograph(s) with a transparent layer) representing jewelry components to create a jewelry design together over a network at the same time. According to an exemplary embodiment of the present invention, a method and/or system of the present invention includes an interface configured to enable individuals to be capable of interacting with each other through a VOIP connection or a real time chat tool. According to an exemplary embodiment of the present invention, a method and/or system of the present invention includes an interface configured to enable individuals to be capable of collaborating with each other in real time to create a custom jewelry design. For example, a bride-to-be and her girl friends might design jewelry together for a wedding. According to an embodiment of the present invention, a method and/or system of the present invention includes an interface configured to enable an individual user to be able to invite others to be able to access the individual user's design in real time. According to an exemplary embodiment of the present invention, a system and/or method of the present invention includes a network-based broker network configured to be able to make a single design stage 1710 available to multiple users. According to an exemplary embodiment of the present invention, a method and/or system of the present invention includes an interface configured to enable an individual who begins to use the design stage 1710 to be capable of selecting whether the design stage 1710 is public for other individuals to view, such as others who are live on the broker network. According to an exemplary embodiment of the present invention, a method and/or system of the present invention includes an interface configured to enable a user to be able to selectively restrict access to the viewing of a design to specific individuals, which can be designated, so that the user is able to control who has collaborative design capabilities to arrange images (and/or photographs with a transparent layer) representing jewelry components and custom jewelry designs. According to an exemplary embodiment of the present invention, interface 1700 is configured to enable the user or users to work at the same time, and can toggle through multiple designs.

According to an exemplary embodiment of the present invention, each bitmap image (and/or photograph with a transparent layer representing a jewelry component), has a unique price associated with it. According to an exemplary embodiment of the present invention, as the user (or users) selects one or more images for their custom jewelry design, the total price displayed changes to reflect the total amounts of the jewelry components represented by bitmap images (and/or photographs with a transparent layer) that the user has selected. According to an exemplary embodiment of the present invention, when a user initiates a purchase process of the bitmap images (and/or photographs with a transparent layer) representing jewelry components, the data is sent to a database and e-commerce engine for the purchase and checkout. According to an exemplary embodiment of the present invention, the bitmap image(s) (and/or photographs with a transparent layer) of the jewelry design(s), will become a flattened layer of the combined images, and output as a screen grab and/or image file in TIFF, JPG, GIFF, PNG, BMP or other bitmap file formats. According to an exemplary embodiment of the present invention, the flattened image layer will be viewable during the e-commerce process. According to an exemplary embodiment of the present invention, as the user initiates e-commerce, a cookie is set using the Session ID and/or user's Profile ID number, so that the exact transaction can be easily restored if the user does not complete the e-commerce process. According to an exemplary embodiment of the present invention, an e-mail is generated and sent to the administrator with all the available data pertaining to the user's or users' incomplete custom design (including but not limited to Session ID, Profile ID(s), design price, bitmap images (and/or photographs with a transparent layer) representing jewelry components and correlating products present in the design, user's or users' name(s), phone number(s) and e-mail address(s)). According to an exemplary embodiment of the present invention, the Custom Jewelry Design Application auto-saves a user's design work periodically, so that if the Custom Jewelry Design Application crashes, the user's custom design can be restored. According to an exemplary embodiment of the present invention, the database will create a handshake with the CMS system so that a record of the design (and its unique URL or hyperlinked button/image) is saved to the user's or users' account(s) in the CRM system for later access, management and sales efforts.

According to an exemplary embodiment of the present invention, when the administrator logs into the CMS and/or CRM system, the CMS and/or CRM system is configured to be capable of notifying the administrator of all transactions that were abandoned (and correlating products present in designs, user's or users' name(s), phone number(s) and e-mail address(s)).

According to an exemplary embodiment of the present invention, the administrator may select to send to a user in an e-mail a personal message from the CMS or CRM (which includes a URL link to the design(s), or a button with a unique ID code), which the user can click on to recreate or purchase upon later receipt. According to an exemplary embodiment of the present invention, the CMS, database and/or CRM may automatically e-mail the user (at set time intervals) a URL link to their uncompleted design(s) (or a button with a unique ID code) the price and an attached image, for example to view their work without recreating the design in the Interface. According to an exemplary embodiment of the present invention, if the user comes back to the website, shopping cart and/or initiates e-commerce checkout for other products, the cookie and database will also make the previously uncompleted purchase design(s) available to the user for e-commerce checkout, for example, a user may spend an hour creating a design and initiate e-commerce, get distracted by a personal issue (or close their browser for some other reason) and come back to the website, shopping cart or interface at a later date and see their previous work available to them for immediate purchase, further editing in the interface or sharing with others (even if the user did not formally save his or her work). According to an exemplary embodiment of the present invention, when a user completes an e-commerce transaction, an e-mail is generated and sent to the user with a picture of his or her purchased custom design(s) and a URL link (or hyperlinked button/image) to further edit and/or share that design(s) with others. According to an exemplary embodiment of the present invention, an e-mail is generated and sent to an administrator (or sub admin account) which contains a URL link (or hyperlinked button/image) to the design(s), an image of the design(s), all of the user's personal data, date of order, date order needs to be shipped (if specified), an itemized list of images (and correlating products, SKU, product ID, quantities therein of each, special notes and inventory available at purchase).

According to an exemplary embodiment of the present invention, some images (and/or photographs with transparent layers) representing jewelry Component(s) may no longer be in inventory. For example, if a user at a later date opens a saved design from their profile account, or clicks on a URL link (or hyperlinked button/image) sent to them via a save or share function, the design will load, and any out of inventory item(s), will be highlighted to communicate to the user it is not presently available. According to an exemplary embodiment of the present invention, when a BITMAP image (and/or photograph(s) with a transparent layer) representing a jewelry component is no longer in inventory, the database will initiate the sending of a notice that the jewelry component is out of stock. According to an exemplary embodiment of the present invention, interface 1700 is configured to enable the alerting of an individual user that a design was created using jewelry components which are no longer in stock, and that he or she may still purchase the existing design arrangement (including out of stock items), but that their order will take an additional amount of time to complete assembly. According to an exemplary embodiment of the present invention, interface 1700 is configured to enable the highlighting an out of stock jewelry component on the design stage 1710, so that a user can easily understand this situation. According to an exemplary embodiment of the present invention if a user opts to purchase an out of stock jewelry product(s), then the interface 1700 will let the database, CMS and e-commerce system know that this purchase contains jewelry component(s) that are out of stock and may also include which jewelry components were ordered that are out of stock and/or how many units of that out of inventory component were ordered.

According to an exemplary embodiment of the present invention, some images (and/or photographs with transparent layers) representing jewelry component(s)) may no longer be in inventory. For example, if a user at a later date opens a saved design from their profile account, or clicks on a URL link (or hyperlinked button/image) sent to them via a save or share function, the design will load, and any out of inventory item(s), will be highlighted to communicate to the user it is not presently available. According to an embodiment of the present invention, when a jewelry component is no longer in inventory, the database is configured to provide notice that this jewelry component is out of stock. According to an exemplary embodiment of the present invention, interface 1700 may alert the individual user that the jewelry design was created using jewelry components which are no longer in stock, and that the user can buy the design without the missing component/s, or to add further to the design before then purchasing a revised jewelry design.

According to an exemplary embodiment of the present invention, a method and/or system of the present invention includes a database configured to send a purchase completion e-mail to a user and a completion e-mail may or may not contain (part or all of the following): a unique URUs (or hyperlinked button/image(s)) of the custom design(s) the user purchased, the individual price of each design, total price, and/or attached image(s) of the design(s) purchased. According to an exemplary embodiment of the present invention, an administrator purchase completion message is sent to the administrator (or sub admin account(s)) and this message may contain some or all of the following: a URL (or hyperlinked button/image) to the design(s), an image of the design(s), all user(s) personal data, date of order, date order needs to be shipped (if specified), an itemized list of images (and correlating jewelry component products, SKU, product ID, quantities therein of each, special notes, inventory available at purchase), and/or a text or image link to an admin area where they order can viewed and managed online.

According to an exemplary embodiment of the present invention, when a purchase of a custom jewelry design is completed, a system message may be generated in the CMS, production management dashboard and/or password protected administration account (or sub admin account/s) and this system message may contain some or all of the following: a URL link (or hyperlinked button/image) to the design(s), an image of the design(s), all user(s) personal data, date of order, date order needs to be shipped (if specified), and/or an itemized list of images (and correlating jewelry component/s, SKU/s, product ID, quantities therein of each, special notes, inventory available at purchase).

According to an exemplary embodiment of the present invention, tolerance thresholds on inventory management can be set by an administrator (or sub admin). According to an exemplary embodiment of the present invention, when a tolerance threshold is reached (which can be set by the admin or sub-admins), the CMS, production dashboard and/or database driven system/s will automatically produce an e-mail for the administrator (or sub admin) notifying them that a particular jewelry Component is running low on inventory.

According to an exemplary embodiment of the present invention, interface 1700, database, CMS and CRM together (or in part), enables user(s) to make custom jewelry designs designed by the user(s), either public or private. According to an exemplary embodiment of the present invention, if the custom jewelry designs are private, then only individuals who have been invited and/or have pre-existing friends of the designer may view, edit, review and purchase the design. According to an exemplary embodiment of the present invention, if the custom jewelry designs are public, then all other user(s) may review, edit, share, comment or purchase the design arrangement created by another user(s). According to an exemplary embodiment of the present invention, each user may view products created by other users which are sorted by price, rating, type of materials, etc. According to an exemplary embodiment of the present invention, users may publish their custom jewelry designs. According to an exemplary embodiment of the present invention, a user(s) may opt to share a design created by the user(s) or linked on other social networking sites by publishing it on the user(s) profile(s) on a social networking site integrated directly into the interface or available externally (such as Facebook, Twitter, Myspace, Bebo or other). According to an exemplary embodiment of the present invention, interface 1700, database, CMS, CRM and e-commerce systems may be integrated directly into API's of social networking sites (such as Facebook, Twitter, Myspace, Bebo or other) or mobile devices (such as iPhone, Andriod and others), whereby the users on any of those specific platforms may interact with the full functionality of interface 1700 directly inside the social network or mobile device, to enable users to create designs, share the designs with friends on the social network/mobile device, publish the designs to their news or status feeds, purchase the designs and perform all the other functions normally available in the Custom Jewelry Design Application. According to an exemplary embodiment of the present invention, a user may opt to install a custom jewelry designer badge which will show all other users viewing their profile, that they have the application installed and what their designs are (with correlated images of the design, price, reviews, descriptions, reviews, comments, etc).

According to an exemplary embodiment of the present invention, an administrator using a web browser or mobile device is capable of logging onto a network based Content Management System (CMS) or Production Management module. According to an exemplary embodiment of the present invention, the administrator can create sub administrator accounts with restricted access and defined access parameters. According to an exemplary embodiment of the present invention, Content Management System (CMS) or Production Management module is configured to enable an administrator to be able to create jewelry component(s) and/or manage (for example, edit or delete) jewelry components, jewelry designs and/or products based on jewelry designs that are stored in the database, and loaded into the interface of the custom jewelry design application. According to an exemplary embodiment of the present invention, the CMS directly affects, writes and deletes data in the database, which creates dynamic network based handshakes with the interface over a network loading on an individual's browser or mobile device. According to an exemplary embodiment of the present invention, when an administrator creates or manages (edit and/or delete) a jewelry component in the CMS system, they will fill in (all or part of the following): fields or upload content for name, tag line, description, product ID number, SKU, technical code, retail price, wholesale price, inventory quantity, primary photo and secondary photos. According to an exemplary embodiment of the present invention, when an individual end user initiates a save, share, collaborative design with other users, or e-commerce purchase of a design, interface 1700 is configured to create a handshake with the database so the unique arrangement of images (and all correlating data in the database) is saved to the individual's profile or session ID in the database (and saves to a session ID if a user has not registered yet or logged in). According to an exemplary embodiment of the present invention, when a user initiates a save, share, collaborative custom jewelry design with other users, or e-commerce purchase of the user's design, the system may require the user to log into an existing profile account (or create one) at which point all session ID and image data arrangement that correlates to active custom jewelry design(s) along with correlating product data about the bitmap image(s) (and/or photograph(s) with a transparent layer), will be merged with the user's profile database records.

According to an exemplary embodiment of the present invention, an administrator is able to produce a report on which jewelry component/s, and/or custom jewelry design/s were most popular to each individual in a selected time period. According to an exemplary embodiment of the present invention, the administrator (or sub admin) can view jewelry components (or saved custom jewelry designs) which were most popular based upon time periods, style, costs, tags, gender of individuals, age of individuals, etc. According to an exemplary embodiment of the present invention, an administrator is able to dynamically manage, create and change the taxonomy of categories and sub-categories of jewelry components and images that can be filtered and accessibly by an individual via their network based interface, whereby the administrator (or sub admin) one day can arrange the taxonomy of products so that an individual filters between categories of strands, gems and charms. According to an exemplary embodiment of the present invention, an administrator may create a new category (for example) called “Special Pendants”, which is available with an original design's strands, gems, and charms filterable and viewable by an individual via the user's network based interface. According to an exemplary embodiment of the present invention, an administrator may create, dynamically alter and edit any category of jewelry component/s in the database taxonomy (or even how the taxonomy is structured).

According to an exemplary embodiment of the present invention, at least one of the pluralities of images which represents jewelry component/s to be used creating a product based on a custom jewelry design includes a transparent background. According to an exemplary embodiment of the present invention, each of the plurality of images (or photograph(s) on a transparent layer) depicts jewelry and/or component(s) arranged together. According to an exemplary embodiment of the present invention, a method and/or system may include applying structure recognition to at least one image. According to an exemplary embodiment of the present invention, a method and/or system may include structure recognition, which includes the use of at least one neural network. According to an exemplary embodiment of the present invention, a method and/or system of the present invention includes displaying the plurality of images (and/or photographs with a transparent layer) representing jewelry components on a display, wherein the displaying comprises the ability to change the view of each the plurality of images. According to an exemplary embodiment of the present invention, a method and/or system includes correlating through the use of a processor, a price to each of the jewelry components and/or product bitmap images (and/or photographs with a transparent layer) representing jewelry components. According to an exemplary embodiment of the present invention, the plurality of bitmap images (and/or photograph(s) with a transparent layer) representing jewelry components are combined through the use of a processor into a single image, wherein the combining comprises transforming the single image into a two-dimensional image. According to an exemplary embodiment of the present invention, each of the plurality of images (and/or photographs with a transparent layer) representing jewelry components is configured such that a location of the image on a display can be changed using input from at least one individual (such as a potential seller of the product and a potential purchaser of the product).

FIG. 21 shows a flow chart of an example of operation of one embodiment of a method for designing jewelry over a network. According to an exemplary embodiment of the present invention some, all or none of the steps of the method can involve human interaction. According to an exemplary embodiment of the present invention, some, all or none of the steps of the method can be automated. According to an exemplary embodiment of the present invention, a processor implemented method for designing jewelry over a network starts at 2102 where a plurality of bitmap images, each of which depicts at least one jewelry component, are transmitted over a network 2104, wherein each of the bitmap images is indexed to a price of at least one jewelry component, and is configured such that its location on a display or view angle can be changed using input received over a network from at least one individual. According to an exemplary embodiment of the present invention, the bitmap images (and/or photograph(s) with a transparent layer) can include TIFF, JPG, GIFF, PNG and MS Paint file formats. According to an exemplary embodiment of the present invention, each of the plurality of images is configured such that a location of the image on a display can be changed using input from at least one individual. According to an exemplary embodiment of the present invention, a location of the image and a view angle on a display can be changed using input from several individuals (such as potential buyer and a potential seller collaborating on a piece of jewelry to be purchased). At step 2106, the plurality of bitmap images are combined through the use of a processor into a single image. The method ends at 2108.

According to an exemplary embodiment of the present invention, a method and/or system includes displaying at least one image on a social network. According to an exemplary embodiment of the present invention, a method and/or system includes displaying at least one image corresponding to a price. According to an exemplary embodiment of the present invention, a method and/or system includes applying structure recognition to at least one image to automatically detect the image.

According to an exemplary embodiment of the present invention, a method and/or system includes displaying at least one jewelry product represented by an image in an Interface. According to an exemplary embodiment of the present invention, the at least one image (and/or photograph(s)) represent a jewelry component comprises a transparent background. According to an exemplary embodiment of the present invention, a method and/or system includes applying structure recognition to at least one image to automatically detect the image. According to an exemplary embodiment of the present invention, structure recognition includes at least one neural network. According to an exemplary embodiment of the present invention, a method and/or system includes displaying the plurality of bitmap images (and/or photograph(s) with a transparent layer) representing jewelry components on a display, wherein the displaying comprises the ability to change the view of each the plurality of images. According to an exemplary embodiment of the present invention, a method and/or system includes correlating through the use of a processor, a price to each of the images. According to an exemplary embodiment of the present invention, the plurality of bitmap images (and/or photograph(s) with a transparent layer) representing jewelry components are combined through the use of a processor into a single image, wherein the combining comprises transforming the single image into a two-dimensional image. According to an exemplary embodiment of the present invention, a method and/or system includes displaying an image(s) on a social network. According to an exemplary embodiment of the present invention, each of the plurality of images (and/or photographs with a transparent layer) representing jewelry components is configured such that a location of the image on a display can be changed using input from at least one individual, wherein the at least one individual comprises a potential seller of the product and a potential purchaser of the product. According to an exemplary embodiment of the present invention, a method and/or system includes displaying a plurality of tools wherein the tools are configured to enable for the creation of at least one of the plurality of bitmap images (and/or photograph(s) with a transparent layer) using input received over a network from at least one individual.

According to an exemplary embodiment of the present invention, the information transmitted over a network can be binary, symbols, text, photographs, holographs, biometric, audio, video, a combination thereof or the like. According to an exemplary embodiment of the present invention, the information transmitted over a network can be transmitted by a human (for example a purchaser of a product and/or service) or be automated without the use of a human.

According to an exemplary embodiment of the present invention, a method and/or system is configured to enable the determining an individual's geographic location for example to determine pricing specific to the person's ability to pay correlated to the area or for example to correlate a potential seller that is geographically close to the potential purchaser. According to an exemplary embodiment of the present invention, a method and/or system determines an individual's geographic location using geo sniffing and/or IP tracking. According to an exemplary embodiment of the present invention geographic location can include computer registered to an individual and/or physical location of the computer within a country, state and/or city.

According to an exemplary embodiment of the present invention, a method and/or system provides for advertising, selling and purchasing over a network that has the capability of notifying users of their completed e-commerce transaction via e-mail or wireless device. According to an exemplary embodiment of the present invention, a method and/or system provides for a handshake or data link between an e-commerce system, a payment gateway and a credit card processor for the purposes of completing transactions over a network. According to an exemplary embodiment of the present invention, a method and/or system provides for payment over a network through the use of credit or debit cards or third party payment systems such as Paypal, Google, Amazon or wire transfer.

According to an exemplary embodiment of the present invention, a method and/or system tracks users visiting websites to economically compensate sites for generating traffic.

According to an exemplary embodiment of the present invention, a method and/or system tracks users purchases over a network and is capable of blocking access to Custom Jewelry Design Application on a network for example when the user has failed to make a payment.

According to an exemplary embodiment of the present invention, a method and/or system includes an e-commerce widget that enables a user to easily distribute custom jewelry designs over a network (e.g., using the internet). According to an exemplary embodiment of the present invention, the e-commerce widget dynamically produces HTML code, Java and/or a flash widget, that they can be pasted around the network (e.g., internet and/or wireless web), embed on other webpages or embed via an iframe, which can then be accessed by numerous distributed media platforms at the same time (such as websites, mobile and social networks).

According to an exemplary embodiment of the present invention, a method and/or system enables affiliates to embed or promote the e-commerce widget (e.g., filled with custom jewelry designs and/or linking to Custom Jewelry Design Application) or marketplace, and to earn a commission on the sales of custom jewelry designs that they produce through the e-commerce widget. According to an exemplary embodiment of the present invention, an affiliate signs up for an account, and enters their bank account information or Paypal, Google or Amazon account information with the e-commerce widget dynamically tracking and distributing the commissions to the affiliate. According to an exemplary embodiment of the present invention, the e-commerce widget and/or marketplace have a system where the supplier or seller can manage their account by tracking information including sales, visitors, affiliates, affiliate sales, affiliate locations where the e-commerce widget or marketplace is being accessed and the source of traffic. According to an exemplary embodiment of the present invention, the affiliate account will be able to track visitors, commissions, click through rates, traffic sources and payment history through e-commerce widget and marketplace. According to an exemplary embodiment of the present invention sellers are able to customize the look and feel of the e-commerce widget and their marketplace store through an internet based designer interface by uploading HTML code and graphics, or selecting from templates provided by site administrators or other users enabling the sellers to create a shopping environment that matches the look and feel of their website, graphics and logo.

According to an exemplary embodiment of the present invention, interface 1700 and Design Stage 1710 are configured to provide functionality that enables a user to use a writing tool to enter a custom character, word or phrase, and place that writing on a specific charm or piece of organic material (such as bone or wood) that they wish to use as part of their custom jewelry design. According to an exemplary embodiment of the present invention, user is able to change the size, position, font and placement of the custom writing, so long as it fits into the dimensions of the selected charm. According to an exemplary embodiment of the present invention, an administrator (or sub admin) may use the CMS system and/or database to select which charms and what part of the charms are available for placing of custom writing. According to an exemplary embodiment of the present invention Interface 1700 may use pixel detection on a selected charm, to detect whether or not the text writing is occurring within the charm, and block the user from adding more characters that will make their custom writing extend beyond the dimensions of the charm. According to an exemplary embodiment of the present invention Interface 1700 may (or may not) display real time the Custom Writing that the user desires on the bitmap image (and/or photograph(s) with a transparent layer) representing the jewelry component(s). This real time display of custom writing on the actual bitmap image (and/or photograph(s) with a transparent layer representing the jewelry component), may (or may not) occur via Flash, Java, C++, C, Objective C or combination therein, that may (or may not) include other web display technologies (such as HTML, CSS, XML, DHTML, etc). According to an exemplary embodiment of the present invention, the CMS and/or database will inform Interface 1700 of which charms (or piece of metal) the user is viewing may be used to place custom writing. According to an exemplary embodiment of the present invention, a specific taxonomy, filter, text demarcation, or highlighted state may indicate to the end user that charms they are viewing can contain custom writing. According to an exemplary embodiment of the present invention, the interface 1700 and design stage 1700 are configured to display a writing tool, which enables the user to freely type, change size, font, placement and rotation of their writing on charms which are available for personalized text. According to an exemplary embodiment of the present invention, Interface 1700 is configured to create a handshake with the database so that the personalized text that the user has placed, will keep an association with the specific charm (or piece of metal) that text was placed on, so that the design can be saved (and recreated later), modified at a later date, shared with friends and/or collaboratively changed with friends or purchased. According to an exemplary embodiment of the present invention, the custom text that is placed and manipulated in the interface 1700, will occupy a distinct layer. According to an exemplary embodiment of the present invention, when an image of the custom design is taken during a saving, sharing or purchase process, the layer of text will be flattened with all the other layers of images (and/or photographs with a transparent layer representing jewelry components) and jewelry components active (which are used to represent the user's custom jewelry design). According to an exemplary embodiment of the present invention, the new single bitmap image (and/or photograph(s) with a transparent layer) may be saved in a TIFF, PNG, GIF, BMP, JPEG or other file bitmap format. According to an exemplary embodiment of the present invention, this new single layer image will represent the new total design including the users custom text. According to an exemplary embodiment of the present invention, when a purchase is completed, the user will receive a confirmation e-mail populated by the database, which lists the specific custom text that was ordered. According to an exemplary embodiment of the present invention, additionally when a purchase is completed the administrator (or sub admin) will receive a confirmation e-mail populated by the database, which lists the specific custom text that was ordered so that the manufacturing can reproduce the design requirements of the user.

According to an exemplary embodiment of the present invention, the system will e-mail users who abandon the check out process midway and will provide a link to their custom design(s), a link to the shopping cart (containing contents of their custom design(s), image(s) (and/or photographs with a transparent layer) representing jewelry components, and price(s) of their custom design (along with a unique URL link (or hyperlinked button/image). According to an exemplary embodiment of the present invention, an administrator (or assigned sub admin) may specify through admin a password protected administration panel, when and how often users who abandon checkout, will get the contents of their work sent to them via automated e-mails. According to an exemplary embodiment of the present invention, when the user gets the e-mail, it will contain direct links to their custom design(s) so they can further edit, share or purchase the design(s). According to an exemplary embodiment of the present invention, when the user gets the e-mail it will contain a direct link to the shopping cart e-commerce engine so that the user may easily re-initiate checkout process. According to an exemplary embodiment of the present invention, interface 1700 is configured to enable the user to see the image of the completed custom jewelry design automatically populating the e-commerce engine (with photos of their design/s) visible as they move through checkout and/or payment.

According to an exemplary embodiment of the present invention, the database is configured to enable the tracking and saving of individual (or collective) custom designs, charms, gems and strands with which a user interacts. According to an exemplary embodiment of the present invention, the database is configured to enable the tracking and saving the individual (or collective) custom designs, charms, gems and strands with which a user interacts and this data will be sent to an Automated Marketing Sequence Engine (AMSE) that will interact with the user. According to an exemplary embodiment of the present invention, the AMSE is configured to enable the displaying of a password protected control panel where an administrator (or sub admin) can create automated marketing sequences interacting with the user in which the user is classified into groups of users based upon the user's behavior (user's personal data like a birthday, jewelry components they like, having sent custom designs to checkout but abandoning checkout before completed, having sent custom designs to checkout and completing purchases, and other classification scenarios). According to an exemplary embodiment of the present invention, the admin (or sub admin) creates unique sequences based upon the classification of the user which can select a time period the admin wants an e-mail and/or an Offline Personalized Post Card (OPPC) e-mailed and/or mailed physically to the user. According to an exemplary embodiment of the present invention, classification of users can be dynamically created by the admin via the control panel. According to an exemplary embodiment of the present invention, a user may be classified into a group based upon their tracked behavior on the site or via smart forms that the user populates. According to an exemplary embodiment of the present invention, a smart form is configured to include fields specifying a user's birthday, the user's partner's contact info (so the partner may be contacted by the AMSE to purchase a virtual gift for custom jewelry design), whether the user is a mother, or other dynamic data fields desired by the Admin. According to an exemplary embodiment of the present invention, the data collected via the smart form is stored in a database and is available for sub-filtering to create groups available for targeting by the AMSE to promote and drive business to the Custom Jewelry Design Application. An example list of classifications that will be the recipient of e-mails or OPPC, may be users who created a custom design but abandoned checkout, users who identified themselves as mothers, partners to a user, a user's birthday, users who created a custom design and completed purchase (among other classification types). According to an exemplary embodiment of the present invention, the e-mail or OPPC will dynamically contain images of jewelry components or completed custom designs the user has been interacting with or purchased. According to an exemplary embodiment of the present invention, all abandoned checkout customers will be e-mailed by the AMSE with images of the designs they are created yet did not purchase. For example, the admin may choose to send all abandoned checkout classified customers an e-mail which contains a discount code, a distinct URL dynamically created with the user's name (e.g. sarah.jones.patenteddesignssolutions.com to redeem their code), images of the custom designs or individual Jewelry components that the user was interacting with and/or abandoned at checkout and a message sent to all users in the specific class personalized with the users name. According to an exemplary embodiment of the present invention, the admin may select to send all abandoned checkout classified customers an OPPC containing a discount code, a distinct URL dynamically created with the user's name (i.e., sarah.jones.patenteddesignssolutions.com to redeem their code), images of the custom designs or individual Jewelry components that the user was interacting with and/or abandoned at checkout and a message sent to all users in the specific class personalized with the users name. According to an exemplary embodiment of the present invention, the AMSE may be used to automatically send e-mails and OPPC's to users a week before their birthday—sending them images of custom designs, jewelry components or completed designs with which the user has interacted with in the past. According to an exemplary embodiment of the present invention, the database tracks and stores user behavior, and is able to supply the AMSE the user's data pertaining to the individual jewelry component(s) or custom design(s) that the user was interacting with, thereby providing the critical ingredient of dynamic content personalized yet automated and sent via the e-mail, OPCC, physical mail or mobile device.

According to an exemplary embodiment of the present invention, interface 1700 is configured to enable a user can to buy a virtual gift card for the Custom Jewelry Design Application. According to an exemplary embodiment of the present invention, the user is able to buy preselected increments or a custom selected amount of credit. According to an exemplary embodiment of the present invention, the user is able to enter the contact information of the recipient (e.g, name, e-mail, mailing address, phone, etc). According to an exemplary embodiment of the present invention, the user is also able to select when the user wants the virtual gift card to be sent to the recipient using a calendar date selection widget (e.g., enabling the user to buy and send a virtual gift card to the Custom Jewelry Design Application on a person's birthday, mother's day, etc). According to an exemplary embodiment of the present invention, as the user enters how much credit the user wants to buy as they gift, a virtual image representation of a gift card dynamically changes to reflect the amount purchased, the name of the recipient, the name of the sender and any personal message the user wants to send to the recipient. According to an exemplary embodiment of the present invention, this virtual image representation is e-mailed to the user who purchased it, and displayed at completion of purchase, so that the user can print the image to give it physically. According to an exemplary embodiment of the present invention, if a recipient was entered for automatic sending, the virtual e-mail and critical redemption information is sent to the recipient at the specified date so that the recipient can redeem the gift credit to be used when purchasing a custom jewelry design. According to an exemplary embodiment of the present invention, if a physical mailing address was supplied by the user, the database will send the AMSE the required information to produce a personalized postcard which will be sent to the recipient. According to an exemplary embodiment of the present invention, if a phone number was supplied, the database will generate an phone call to the recipient with instructions to redeem the gift card code.

According to an exemplary embodiment of the present invention, a Multi Level Marketing Engine (MLME) is configured to facilitate commission tracking and payment disbursements. According to an exemplary embodiment of the present invention, the MLME is configured to enables users to invite and earn commissions from other users they have brought to the Custom Jewelry Design Application. According to an exemplary embodiment of the present invention, within the Custom Jewelry Design Application, users are able to load individual or multiple contacts (for example via CSV, Excel, Outlook, Mozilla and/or other contact files), or bulk load/invite contacts from social networking sites (such as Facebook, Myspace, Linkedln, Twitter, etc) using the social network's API connectivity (or 3^{rd} party API contact management tools)—for the purchases of inviting new users to the Custom Jewelry Design Application. According to an exemplary embodiment of the present invention, the FMW is configured to enable users to view all friends they have invited, when they were invited, commissions they have earned from the user, whether the user accepted, add notes next to any friend they invited, has additional contact fields next to each friend so the user can enter a phone number or other personal info, and allows the user to see all the activities their invited friends have taken (e.g., if they have designed, written reviews, purchased designers, invited friends themselves). According to an exemplary embodiment of the present invention, when a user invites friends, those e-mail addresses, user ID's and social networking ID's may be stored in a networked database and tracked as a sub-user to the invitee to the Custom Jewelry Design Application. According to an exemplary embodiment of the present invention, the users are able to send and receive messages to each other within the Custom Jewelry Design Application. According to an exemplary embodiment of the present invention, when a user sends a message, writes a review and/or posts a new design, the system may send an e-mail or text message (depending on settings selected by user), notifying them that they have received a message. According to an exemplary embodiment of the present invention, a system message and e-mail/text message may be generated when an invited friend creates a piece of jewelry, writes a review, invites friends themselves or purchases a design.

According to an exemplary embodiment of the present invention, administrator(s) (or sub admins) can set the commission thresholds for the MLME earned by individuals who invite friends that end up purchasing designs within the Custom Jewelry Design Application. According to an exemplary embodiment of the present invention, these commission thresholds are managed from a password protected networked control panel, where classes of users' commissions can be set, adjusted and tracked. For example, when an original user invites 10 friends to the Custom Jewelry Design application, of those 10 invited friends 2 end up designing and purchasing a jewelry creation, giving the original user a 15% commission on the sales from their invited friends (percentage can vary depending on admin settings) and each of the friends in the various levels of the downline, will also receive commissions for referring users who purchase. According to an exemplary embodiment of the present invention, users may be able to see commissions they earn and commissions they have earned from immediate users whom they invited, and from users in the downlines whom they invited to the Custom Jewelry Design Application. According to an exemplary embodiment of the present invention, a user can pay with their Paypal, Google, Amazon (or other payment system info), ACH info, bank account and wire transfer info, or opt to have a check mailed to a physical address. According to an exemplary embodiment of the present invention, from the MLME, an admin (or subadmin) can run reports on commissions as well as set times when commission reports and financial disbursements will be run automatically. According to an exemplary embodiment of the present invention, the admin can toggle the MLME to have the system send them a report stating when commissions are due. According to an exemplary embodiment of the present invention, the system is configured to be capable toggling the MLME to automatically disburse money to the users. According to an exemplary embodiment of the present invention, when the money is disbursed, the MLME will interact with the database and send the appropriate amount of funds to the user's selected method of payment and/or credit towards a future purchase they wish to receive in lieu of actual payment.

According to an exemplary embodiment of the present invention, the MLME will reward commissions to users who purchase designs from another user. According to an exemplary embodiment of the present invention, a commission is earned by a first user when a second user purchases one of the first user's designs in the Custom Jewelry Design Application. According to an exemplary embodiment of the present invention, the commission is earned by the user who designed the piece that was purchased by another user, even if the purchasing user was not a friend or invited by the designing user. According to an exemplary embodiment of the present invention, an admin can manage and produce reports and designate commission amounts to be paid to a designing user. According to an exemplary embodiment of the present invention, users can opt to receive their commissions as a credit towards a future design they purchase or as an actual payment. According to an exemplary embodiment of the present invention, a user can enter their Paypal, Google, Amazon (or other payment system info), ACH info, bank acct, wire transfer info, or opt to have a check mailed to a physical address.

According to an exemplary embodiment of the present invention, the Custom Jewelry Design Application supports a class of users that have wholesale access rights and/or pricing to the interface of the Custom Jewelry Design Application. According to an exemplary embodiment of the present invention, a wholesale customer can access the Custom Jewelry Design Application via a password protected environment (or other means), and get access to a discounted pricing structure for each jewelry component in the Custom Jewelry Design Application, that is specific and available to the wholesale users only, for example a 3 mm charm may cost $2.5 to a wholesale customer, whereas it would be $5 to all other users. According to an exemplary embodiment of the present invention, the pricing of Jewelry component products available in the Custom Jewelry Design Application is controlled and managed via the Content Management System (CMS) through password protected admin (or sub admin access). According to an exemplary embodiment of the present invention, each individual component available for use in creating full jewelry assemblies is stored in a database (and managed through the CMS). According to an exemplary embodiment of the present invention, fields for wholesale price and retail price exists in the database. According to an exemplary embodiment of the present invention, when a wholesale user authenticates their access via a password, secure link or other means, the database and interface of the Custom Jewelry Design Application recognize that it should present the wholesale price to the user. According to an exemplary embodiment of the present invention, the system recognizes that the interface and database should use the wholesale price of each jewelry component to determine the total price of any active jewelry design the wholesale customer is creating.

According to an exemplary embodiment of the present invention, Interface 1700 is configured to enable a user is able to browse jewelry components using tags that have been entered by an administrator (or sub admin) via the CMS or by other front end users via the interface 1700. According to an exemplary embodiment of the present invention, a user is able to browse jewelry components through tags that have been entered by an administrator (or sub admin) via the CMS or by other front end users via the Interface, and these tags may be categories such as (but not limited to): Christian, delicate, Buddha's, chunky, edgy, romantic, silver, gold, plated, pewter, bronze, copper, etc). According to an exemplary embodiment of the present invention, the user can browse these tags through a drop down, radio buttons, search field, folders, most popular, price, reviews, etc.

According to an exemplary embodiment of the present invention, a user is able to save and add to favorites jewelry components or completed designs that they want to easily access again later. According to an exemplary embodiment of the present invention, when a user adds items to favorites, they can add a tag, description or classify the jewelry component and/or design into a specific category and/or folder for easier management and organization later access.

According to an exemplary embodiment of the present invention, a user can select or deselect to have a ruler visible so that the user is able to determine the size of the design or jewelry components on the design stage 1710 while viewing jewelry designs or creating custom jewelry designs. In one instance, the user may have an option to toggle measurement units and increments or whether the ruler is even displayed and in another instance, the ruler is always present (or not present) as selected (by the admin or sub-admins) ands the user zooms in or zooms out the ruler scales proportionately with resolution increments, which are set for example by the admin or sub-admins.

According to an exemplary embodiment of the present invention, a user can toggle what financial currency prices are displayed in the interface 1700. In another instance the user can select which language they wish to have the interface 1700 display their jewelry design and/or tools and/or names of jewelry component products and/or price and/or description of the jewelry components.

According to an exemplary embodiment of the present invention, the Custom Jewelry Design Application can be accessed through a kiosk or network terminal device located at physical locations (such as airports, boutiques, malls). This kiosk or network terminal device can provide the full custom jewelry design functionality to users so that they design, create, share, save and/or purchase custom jewelry designs.

According to an exemplary embodiment of the present invention, when a user is connecting jewelry components, the user may opt to use the snap detection module. The snap detection module, allows for interface 1700 to detect where and how bitmap images (and/or photograph(s) with a transparent layer) representing jewelry components fit together. In some instances the Snap Detection module may detect the top center, corners, middle on any side, or bottom center of a bitmap image (and/or photograph(s) with a transparent layer) representing a jewelry component (for example a charm, connector, gem, cap and/or clasp), so that interface 1700 knows how to assist the user, in fitting the jewelry component with another bitmap image (and/or photograph(s) with a transparent layer) representing jewelry component/s, that are present in the user's custom jewelry design and in this way a user, for example, could easily hang charms on the track of strand, hang a charm or connector form another charm or connector, hang gems/stones/beads from a strand, hang gems/stones/beads from a charm or connector, add a bit of chain to a strand and/or add a bit of pearl/gem/beads to a strand, etc.

According to an exemplary embodiment of the present invention within a Flash or Java based interface where users are able to design custom jewelry, a function exists that makes pre-arranged collections of bitmap images (and/or photograph(s) with a transparent layer) available which represent jewelry components arranged in a preset template design for the user and in this way a user is able to buy, save and/or share a pre-arranged collection of bitmap images (and/or photograph(s) with a transparent layer) representing jewelry components arranged in a preset template design for the user, or add/edit it further as a starting point, to guide their custom jewelry design process and this function to access pre-arranged collections of bitmap images (and/or photograph(s) with a transparent layer) can be available within pure Flash and/or JAVA interfaces or mixtures of interfaces that utilize combined web display technologies (such as but not limited to HTML, JavaScript, etc).

According to an exemplary embodiment of the present invention, an administrator (or subadmin) is able to toggle which bitmap images (and/or photograph(s) with a transparent layer) representing jewelry components such as charms could have custom engraved and/or prints words, text or numbers placed on it through the front end Interface. According to an exemplary embodiment of the present invention, the Admin (or sub-admin) is able to use a parameter tool to identify within what area the end user of the interface is able to write custom text. According to an exemplary embodiment of the present invention, the Admin (or subadmin) is able to draw the dimensions on top of, underneath or next to the bitmap image (and/or photograph(s) with a transparent layer) representing a jewelry component, to designate what area is available to the end user to write custom text. According to an exemplary embodiment of the present invention, the admin (or sub amin) may also use a parameter tool, to enter in the amount of pixels, x/y coordinates and/or specific numeric size dimensions, that are available to front end users within the interface, to write custom text within a given qualified charm and any dimensions and/or drawings that an admin (or sub admin) placed on a specific bitmap image (and/or photograph(s) with a transparent layer representing jewelry components), may be saved and/or stored in the database and loaded into the front end interface. According to an exemplary embodiment of the present invention, the interface will be able to utilize the information placed by the admin (or subadmin) with the parameter tool, to guide the user of the front end interface, so that custom text does not exceed the dimensions of the specified area on the bitmap image (and/or photograph(s) with a transparent layer representing a jewelry component) and this interface may be accessed through (but not limited to) Flash, JAVA, HTML, JavaScript, or some combination therein of web display technologies.

According to an exemplary embodiment of the present invention, a function exists where the user is able to upload photo(s) into a Flash, Java, Objective C, C++ and/or C based network Interface of the Custom Jewelry Design Application to evaluate how the custom jewelry design looks with the uploaded photo(s). For example, a user might: upload an image of their body in a Flash interface so that they can see how a custom necklace looks with their skin tone or with a specific outfit; upload a photo of their wrist to see how it looks with a custom bracelet design; or upload a photo of a person's facial profile to see how it looks with a custom earring design and when the photo(s) is uploaded, the user is able to load a desired custom jewelry design on top of the photo, so they can arrange the placement of the custom jewelry to the desired location and the user is able to also save or share the combined images of their uploaded photo and the selected custom jewelry design together for later viewing.

It should be understood, of course, that the foregoing relates to exemplary embodiments of the invention and that modifications may be made without departing from the spirit and scope of the invention as set forth in the following claims.

What is claimed:

1. A processor implemented method for designing jewelry over a network, comprising the steps of:
transmitting over a network a plurality of bitmap images to be viewed on a display, wherein each bitmap image:
depicts at least one jewelry component,
is indexed through the use of a processor to an inventory of at least one jewelry component, and
is configured such that a location or orientation of the bitmap image on a display can be changed using input from at least one individual;
and combining through the use of a processor the plurality of bitmap images into a single image.

2. The method for claim 1, wherein at least one of the images comprises a transparent background.

3. The method for claim 1, further comprising applying structure recognition to at least one image.

4. The method for claim 3, wherein structure recognition comprises at least one neural network.

5. The method for claim 1, further comprising displaying at least one image on a display, wherein the displaying comprises the ability to change the view of at least one image.

6. The method for claim 1, further comprising correlating through the use of a processor a price to at least one image.

7. The method for claim 1, wherein the combining through the use of a processor the plurality of images into a single image comprises transforming the single image into a two-dimensional image.

8. The method for claim 1, wherein at least two of the plurality of bitmap images are configured are configured to have a snap fit relationship when one image is placed at least partially on top of the other.

9. The method for claim 1, further comprising displaying at least image on a social network.

10. The method for claim 1, wherein the at least one individual comprises at least one of a potential seller of the product and a potential purchaser of the product.

11. A computer implemented method for designing jewelry over a network, comprising the steps of:
transmitting a plurality of bitmap images, each of which depicts at least one jewelry component, wherein each of the plurality of bitmap images
is indexed to a price of at least one jewelry component,
and is configured such that its location on a display or a view angle can be changed using input received over a network from at least one individual; and
combining through the use of a processor the plurality of bitmap images into a single image.

12. The method for claim 11, wherein each of the plurality of bitmap images further comprises at least one of compressed and uncompressed images.

13. The method for claim 11, wherein each of the plurality of raw BITMAP images is further configured to be displayed inside at least one of a Flash interface further comprising the step of displaying the plurality of raw bitmap images depicting jewelry inside of a Flash Interface, a JAVA Interface and a web-based internet browser window.

14. The method for claim 11, further comprising applying structure recognition to at least one image to automatically detect the image.

15. The method for claim 11, further comprising displaying a plurality of tools wherein the tools are configured to enable for the creation of at least one of the image using input received over a network from at least one individual.

16. A jewelry content management system, comprising:
means for transmitting a plurality of bitmap images over a network, wherein at least one of the bitmap images depicts jewelry and each of the plurality of bitmap images corresponds to both a jewelry component in an inventory and to a price, and is configured so that at least one of its location on a display and a view angle can be changed using input from at least one individual over a network;
means for displaying the plurality of bitmap images; and
means for combining the plurality of bitmap images into a single image, wherein the means for combining comprises a computer.

17. The system of claim 16, further comprising means for recognizing an image.

18. The system of claim 16, further comprising means for correlating an image to an item in at least one inventory.

19. The system of claim 16, wherein the plurality of images are configured, to be viewed by an individual when any of the plurality of images is located at least partially on top of any of the other plurality of images.

20. The system of claim 16, wherein the means for combining comprises snap fitting means which is configured to snap fit together at least two of the plurality of images.
